(19) United States
(12) Patent Application Publication
(10) Pub. No.: US 2023/0385468 A1
(43) Pub. Date: Nov. 30, 2023

(54) SYSTEMS AND METHODS FOR GENERATING DIGITAL TWINS

(71) Applicant: Accenture Global Solutions Limited, Dublin 4 (IE)

(72) Inventors: Zaid Tashman, San Francisco, CA (US); Matthew Kujawinski, San Jose, CA (US); Sanjoy Paul, Sugar Land, TX (US); Neda Abolhassani, San Mateo, CA (US)

(21) Appl. No.: 17/828,014

(22) Filed: May 30, 2022

(51) Int. Cl. G06F 30/12

(52) U.S. Cl. CPC G06F 30/12; G06F 2111/08

(57) ABSTRACT

Aspects of the present disclosure provide systems, methods, and computer-readable storage media that support ontology driven processes to generate digital twins having extended capabilities. To generate the digital twin, an ontology may be obtained and modified to define additional types of data, such as events and metrics, for incorporation into the digital twin. The ontology, once modified, may be instantiated as a knowledge graph having the additional types of data embedded therein. The embedded data may be used to convert the knowledge graph to a probabilistic graph model that may be queried to extract information from the digital twin in a probabilistic manner. Additionally, multiple ontologies may be utilized to create a digital twin-of-digital twins, which enables more complex digital twins to be generated (e.g., digital twins of entire ecosystems), and enables new insights and understanding of the various components and interactions between the components of the ecosystem.

### TECHNICAL FIELD

The present disclosure relates generally to system modelling and more specifically to systems for generating and extending digital twins representing real world counterparts.

### BACKGROUND

Presently, entities across many different industries are seeking to incorporate the use digital twins to test, streamline, or otherwise evaluate various aspects of their operations. One such industry is the automotive industry, where use of digital twins has been explored as a means to analyze and evaluate performance of a vehicle. To illustrate, a digital twin of a vehicle may be used as a means to safely evaluate performance of autonomous vehicles in mixed driver environments (i.e., environments where autonomous vehicles are operating in the vicinity of human drivers). As can be appreciated from the non-limiting example(s) above, the ability to analyze performance or other factors of a system or process using a digital twin, rather than its real world counterpart (e.g., the vehicle represented by the digital twin), can provide significant advantages. Although the use of digital twins has proved useful across many different industries, much of the current interest is focused on the benefits that may be realized by using digital twins and other challenges that have gone unaddressed.

One particular challenge that remains with respect to the use of digital twins is the creation of the digital twins themselves. For example, tools currently exist to aid in the creation or use of digital twins, but most existing tools are limited in the sense that they may be suitable for specific use case (e.g., creating a digital twin of a physical space, such as a building) but not suitable for other use cases (e.g., creating a digital twin of a process). Additionally, an entity may offer a digital twin platform specific to systems, products, or services of the entity, but such digital twin platforms may not be capable of being utilized for other systems, products, or service (i.e., the digital twin platform is only compatible with the entity's system(s), products, services, etc.). Furthermore, such entity-specific digital twins are not capable of being modified or customized by users, thereby limiting the information that may be obtained from the digital twin to those use cases approved or created by the entity, rather than the ultimate end users of the digital twin platform.

As a result, users of digital twins may seek to utilize multiple tools to develop digital twins covering different portions of a use case of interest. In such instances additional challenges may occur, such as digital twins created using different tools being incompatible with each other, thereby limiting the types of analysis and insights that may be obtained using the digital twins. Additionally, some digital twin creation tools are not well-suited with respect to addressing changes to the real world counterpart and may require re-designing and rebuilding the digital twin each time a changes to the real world counterpart occur. This can be particularly problematic for use cases involving industries where changes frequently occur and new business requirements are constantly changing, such the manufacturing industry. An additional challenge that occurs when creating digital twins is that existing platforms or tools for creating digital twins do not support customization of the types of information that can be used with the digital twin, thereby limiting the ability to create a digital twin that utilizes information that allows meaningful evaluation of a use case of interest. For example, it can be difficult to use statically designed digital twin creation tools (i.e., digital twin tools designed for a specific use case or real world counterpart) with certain types of information, such as time series information or a new use case. This is because static digital twin design tools and platforms are designed to create digital twins for a specific use case or real world counterpart with data defined apriori and such tools do not enable customization of the digital twin to reflect changes to the use case or real world counterpart for which the tools or platforms were designed. Another challenge is scaling of digital twins. For example, a digital twin may describe a set of data that may be used for evaluation purposes, but the dataset may be limited in size or limited in the data structure complexity and may not support the ability to incorporate new more complex types of information, such as time-series data or hierarchical data. Thus, while digital twins have shown promise as a tool for evaluating real world designs, the above-described drawbacks have limited the benefits that can be realized by using digital twins.

### SUMMARY

Aspects of the present disclosure provide systems, methods, and computer-readable storage media that support ontology-driven modeling processes and tools to generate digital twins with extended capabilities. The disclosed processes for generating digital twins may start by obtaining an ontology representing a real world system, machine, process, workflow, organization, application, and the like. The ontology may be used to construct a digital twin, which may initially be represented as a knowledge graph having nodes connected by edges, where the edges represent semantic relationships between the nodes.

While the semantic relationships obtained by instantiating the ontology as a knowledge graph may enable logical inferences to be derived from the digital twin, embodiments of the present disclosure provide the ability to apply extensions to the digital twin that enable new types of insights and information to be obtained from the digital twin. For example, aspects of the present disclosure provide for extending digital twins through embedding of data and models in the digital twin. Moreover, the extension tools provided by embodiments enable incorporation of data types that are difficult to incorporate into digital twins using existing digital twin platforms and tools, such as time series data, hierarchical data, or other types of data. To facilitate incorporation of time series data, the disclosed systems and methods are provided for designing and customizing data structures that may be utilized to organize time series data into collections of observations, which may be added to the digital twin as data nodes. The extension of the digital twins according to embodiments may also include converting the knowledge graph to a probabilistic graph model, thereby providing a digital twin that can be used to extract new types of information from the digital twin. For example, while existing digital twins may enable certain types of information to be obtained from a digital twin, such as logical inferences, digital twins extended in accordance with the present disclosure may provide probabilistic querying capabilities that enable probability distributions to be obtained and used to obtain information that is more complex than mere logical inferences, such as answering “What if?” questions (e.g., what is the probability of X, given Y and Z).

In addition to providing a way to incorporate new data types and supporting probabilistic querying, aspects of the present disclosure may also enable extension of digital twins to support optimization under uncertainty capabilities. For example, extensions may be applied to a digital twin to convert one or more nodes to decision nodes, target nodes, and utility nodes, which are custom node types that may be used to solve optimization-type problems using the digital twin. For example, a decision node may represent a parameter that may be used to target outcomes for optimization, a target node may correspond to the target outcome for the optimization problem, and utility nodes may represent derived data obtained from the data embedded in the digital twin (e.g., using the above-mentioned data embedding extensions) that may be used during the optimization. Using such an extension enables a digital twin to be queried in a manner that optimization problems associated with the real world counterpart may be evaluated and solved (e.g., how long should a robot charge for to ensure optimum throughput of tasks performed by the robot). Moreover, such optimizations may be performed in a manner that accounts for uncertainty (e.g., account for unknown circumstances associated with the optimization problem) and that returns probability distribution data associated with the optimizations output in response to a query of the digital twin.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram illustrating an exemplary system that supports creation of digital twins according to aspects of the present disclosure;

FIG. 2A shows a block diagram illustrating exemplary aspects of a knowledge graph in accordance with aspects of the present disclosure;

FIG. 2B shows a block diagram of a knowledge graph in accordance with aspects of the present disclosure;

FIG. 2C shows a block diagram illustrating a knowledge graph having time series data incorporated therein in accordance with aspects of the present disclosure;

FIG. 2D shows a block diagram illustrating a digital twin providing probabilistic reasoning capabilities in accordance with the present disclosure;

FIG. 3A shows a block diagram illustrating a process for obtaining time series data into a digital twin in accordance with the present disclosure;

FIG. 3B shows a block diagram illustrating examples of a class hierarchy for incorporating time series data into a digital twin in accordance with aspects of the present disclosure;

FIG. 4A shows a block diagram of digital twin generated in accordance with aspects of the present disclosure;

FIG. 4B shows a block diagram of an extended probabilistic graph model in accordance with aspects of the present disclosure;

FIG. 4C shows a block diagram of an extended probabilistic graph model in accordance with aspects of the present disclosure;

FIG. 5A shows a diagram illustrating an exemplary probability distribution obtained from digital twins generated in accordance with aspects of the present disclosure;

FIG. 5B shows another diagram illustrating an exemplary probability distribution obtained from digital twins generated in accordance with aspects of the present disclosure;

FIG. 5C shows yet another diagram illustrating an exemplary probability distribution obtained from digital twins generated in accordance with aspects of the present disclosure;

FIG. 5D shows an additional diagram illustrating an exemplary probability distribution obtained from digital twins generated in accordance with aspects of the present disclosure;

FIG. 5E shows an additional diagram illustrating an exemplary probability distribution obtained from digital twins generated in accordance with aspects of the present disclosure;

FIG. 5F shows an additional diagram illustrating an exemplary probability distribution obtained from digital twins generated in accordance with aspects of the present disclosure;

FIG. 5G shows an additional diagram illustrating an exemplary probability distribution obtained from digital twins generated in accordance with aspects of the present disclosure;

FIG. 6 shows a block diagram illustrating an exemplary user interface providing functionality for extending knowledge graphs in accordance with aspects of the present disclosure; and

FIG. 7 is a flow diagram of an exemplary method for generating digital twins having extended capabilities according to one or more aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, and computer-readable storage media that support ontology driven processes to generate digital twins having extended capabilities. To generate the digital twin, an ontology may be obtained and modified to define additional types of nodes, such as events and metrics, for incorporation into the digital twin. The ontology, once modified, may be instantiated as a knowledge graph having the additional types of nodes embedded therein. The embedded nodes may be used to convert the knowledge graph to a probabilistic graph model that may be queried to extract information from the digital twin in a probabilistic manner. Additionally, multiple ontologies may be utilized to create a digital twin-of-digital twins, which enables more complex digital twins to be generated (e.g., digital twins of entire ecosystems), and enables new insights and understanding of the various components and interactions between the components of the ecosystem (e.g., building an ecosystem of a product lifecycle from raw materials to manufacturing and delivery of the product to a user and all processes in between).

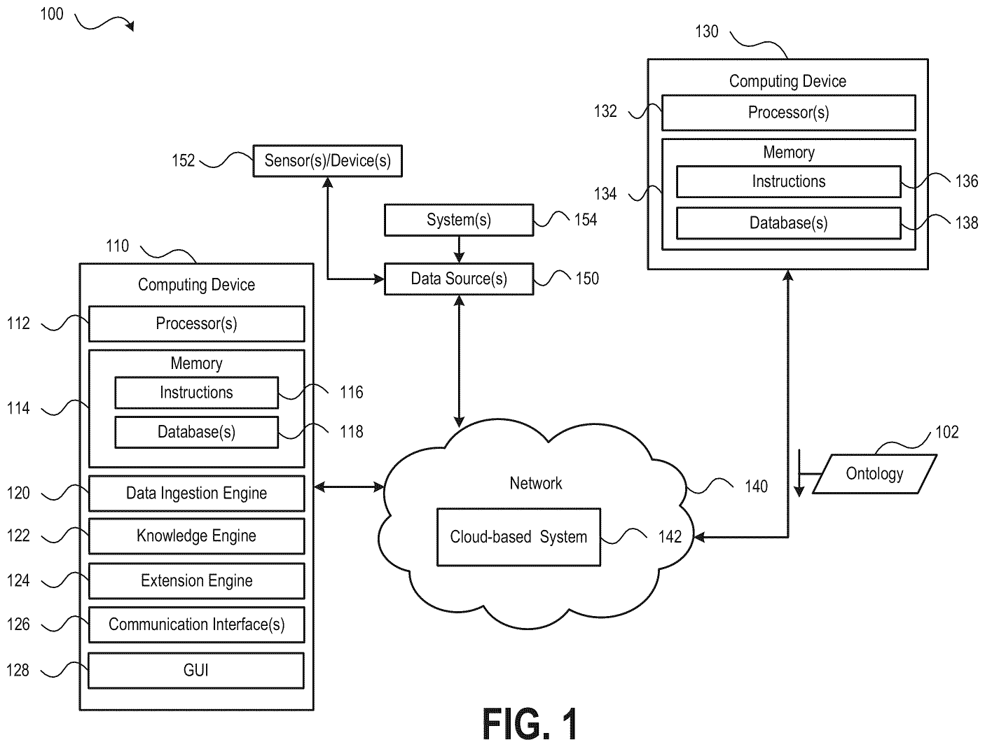

Referring to FIG. 1, a block diagram illustrating an exemplary system that supports creation of digital twins according to aspects of the present disclosure is shown as a system 100. As shown in FIG. 1, the system 100 includes a computing device 110, a computing device 130, one or more networks 140, a cloud-based system 142, and one or more data sources 150. The computing device 110 may include or correspond to a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The computing device 110 includes one or more processors 112, a memory 114, a data ingestion engine 120, a knowledge engine 122, an extension engine 124, and one or more communication interfaces 126. In some implementations the computing device 110 may also provide one or more graphical user interfaces (GUIs) 128 that enable a user to interact with the functionality described in connection with the computing device 110. In additional or alternative implementations the GUI(s) may be provided by another device of the system 100, such as computing device 130. In some other implementations, one or more of the components 120-128 may be optional, one or more of the components 120-128 may be integrated into a single component (e.g., the data ingestion engine 120 and the knowledge engine 122 may be combined, etc.), one or more additional components may be included in the computing device 110, or combinations thereof (e.g., some components may be combined into a single component, some components may be omitted, while other components may be added).

It is noted that functionalities described with reference to the computing device 110 are provided for purposes of illustration, rather than by way of limitation and that the exemplary functionalities described herein may be provided via other types of computing resource deployments. For example, in some implementations, computing resources and functionality described in connection with the computing device 110 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the computing device 110 may be performed by one or more servers or a cloud-based system 142 that communicates with one or more client or user devices, such as the computing device 130.

The one or more processors 112 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the computing device 110 in accordance with aspects of the present disclosure. The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 110 may be stored in the memory 114 as instructions 116 that, when executed by the one or more processors 112, cause the one or more processors 112 to perform the operations described herein with respect to the computing device 110, as described in more detail below. Additionally, the memory 114 may be configured to store data and information in one or more databases 118. Illustrative aspects of the types of information that may be stored in the one or more databases 118 are described in more detail below.

The data ingestion engine 120 provides functionality for collecting data to support the functionality provided by the computing device 110. In particular, the data ingestion engine 120 may provide functionality for capturing data that may be used to extend the capabilities of a digital twin created using the computing device 110. For example, the computing device 110 may be configured to create digital twins in an ontology-driven manner and then extend the capabilities of the digital twin by modifying the ontology based on data captured by the data ingestion engine, as described in more detail below. As a non-limiting example of the types of data that may be used to extend the capability of a digital twin, the data ingestion engine 120 may support the capture and incorporation of time-series data into a digital twin.

The knowledge engine 122 provides functionality for generating a digital twin based on an ontology provided to the computing device and data. For example, the computing device 130 may provide an ontology 102 to the computing device 110 and the ontology may include information descriptive of a real world system, process, device, and the like. The data may correspond to information obtained from the real world system, process, device, etc., such as operational data, configuration data, output data, performance data, and the like. As described in more detail below, the knowledge engine 122 may generate a digital twin based on the ontology 102. For example, the knowledge engine 122 may provide functionality for creating a digital twin corresponding to the real world counterpart associated with the ontology 102. As described in more detail below, the digital twin may be created by instantiating the ontology 102 as a knowledge graph.

The extension engine 124 provides functionality extending the knowledge graph-based digital twin. For example, the extension engine 124 may provide functionality for enabling incorporation of new types of data into a digital twin, such as time series data. As will be described in more detail below, enabling digital twins to be extended to support new types of data may enable the digital twins to be used in new ways and to provide new insights with respect to the real world counterparts of the digital twins. The extension engine 124 may provide functionality enabling modification of a digital twin to provide capabilities for optimization of decision making under uncertainty and to provide probabilistic reasoning capabilities.

Furthermore, the functionality provided by the extension engine 124 may enable digital twins to be created in a system-of-systems-type manner, which may enable rapid development of new types of complex digital twins that are currently not able to be created using existing tools due to the limitations described above. For example, a system-of-systems-type digital twin machinery present in an assembly plant or factory may be modelled. Additionally, the assembly plant or factory may also be represented by a digital twin and processes or work flows used by the machinery and assembly plant or factory to produce products may be represented as yet another digital twin. Additional digital twins may be created to represent logistics operations and equipment used to transport the products produced at the assembly plant or factory to consumer-facing endpoints (e.g., stores, etc.) or intermediate destinations (e.g., fulfillment centers, warehouses, etc.), and then to consumers. In this manner, the functionality provided by the computing device 110 for creating digital twins enables complex digital twins to be created in a manner for entire ecosystems, rather than being limited to use case specific design platforms and tools. Exemplary aspects of the functionality provided by the extension engine 124 and other functionality of the computing device 110 are described in more detail below.

The one or more communication interfaces 124 may be configured to communicatively couple the computing device 110 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the computing device 110 includes one or more input/output (I/O) devices (not shown in FIG. 1) that include one or more display devices, a keyboard, a stylus, one or more touchscreens, a mouse, a trackpad, a microphone, a camera, one or more speakers, haptic feedback devices, or other types of devices that enable a user to receive information from or provide information to the computing device 110. In some implementations, the computing device 110 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the computing device 110.

In an aspect, the computing device 110 may provide one or more graphical user interfaces (GUIs) 128. The GUI(s) 128 may be presented to a user (e.g., a user of the computing device(s) 130) and provide functionality for creating digital twins in accordance with the concepts described herein. For example, the GUI(s) 128 may provide interactive elements that enable the user to upload an ontology (e.g., the ontology 102) as part of a digital twin creation process. The GUI(s) 128 may additionally provide interactive elements and functionality for leveraging the capabilities and functionality of the data ingestion engine 120, the knowledge engine 122, and the extension engine 124 during the digital twin creation process to extend the digital twin in accordance with the concepts described herein. In an aspect, the GUI(s) 128 may be provided as part of an application, such as an application stored in the memory 114 and executed by the one or more processors 112 (or similar resources of the computing device 130). In an additional or alternative aspect, the GUI(s) 128 may be provided as part of a browser-based application and the user may access the GUI(s) 128 via a web browser application running on the computing device 130. In yet another additional or alternative aspect, the GUI(s) 128 may be provided by a cloud-based system, such as cloud-based system 142, which may be configured to provide the functionality described herein with reference to the computing device 110 from a cloud-based deployment of computing resources.

As briefly described above, the computing device 110 may be communicatively coupled to one or more computing devices 130 via the one or more networks 140. The computing device 130 may include one or more processors 132, a memory 134, one or more I/O devices (not shown in FIG. 1), and one or more communication interfaces (not shown in FIG. 1). The one or more processors 132 may include one or more microcontrollers, ASICs, FPGAs, CPUs and/or GPUs having one or more processing cores, or other circuitry and logic configured to facilitate the operations of the computing device 130 in accordance with aspects of the present disclosure. The memory 13 may include RAM devices, ROM devices, EPROM, EEPROM, one or more HDDs, one or more SSDs, flash memory devices, NAS devices, or other memory devices configured to store data in a persistent or non-persistent state. Software configured to facilitate operations and functionality of the computing device 130 may be stored in the memory 134 as instructions 136 that, when executed by the one or more processors 132, cause the one or more processors 132 to perform the operations described herein with respect to the computing device 130, as described in more detail below. Additionally, the memory 134 may be configured to store data and information in one or more databases 138. Illustrative aspects of the types of information that may be stored in the one or more databases 138 are described in more detail below.

To generate and extend a digital twin using the system 100, the computing device 110 may receive an ontology 102 from the computing device 130. The ontology 102 may provide an abstracted semantic representation of a real world counterpart to the digital twin being designed, where the real world counterpart may be an entity, machine, process, system, or other real world design. The ontology 102 may define the real world counterpart using a representation that defines concepts, properties, and relationships for the real world counterpart using an accepted body of knowledge (e.g., industry accepted terminology and semantics) and may specify object types and their semantic relation to other object types via graph format. Exemplary formats in which the ontology 102 may be received by the computing device 110 include “.owl“and”.ttl,” files.

As a non-limiting example, an ontology for a manufacturer may indicate the manufacturer has production facilities in one or more geographic locations and include, for each production facility, information representing: a floor plan for the production facility, manufacturing infrastructure present at the production facility (e.g., assembly robots, computing infrastructure, equipment, tools, and the like), locations of the manufacturing infrastructure within the production facility, other types of information, or combinations thereof. It is noted that while the exemplary characteristics of the above-described ontology have been described with reference to a manufacturer domain, the ontologies obtained by the computing device 110 may include ontologies representative of other types of domains, such as ontologies associated with processes (e.g., manufacturing processes, computing processes, biological processes, chemical processes, etc.), ontologies associated with machinery or equipment (e.g., a vehicle, a computing device or component thereof, circuitry, robots, etc.), ontologies associated with biological systems, and the like. Accordingly, it should be understood that the operations disclosed herein with reference to the computing device 110 may be applied to any industry, process, machine, etc. capable of representation via an ontology.

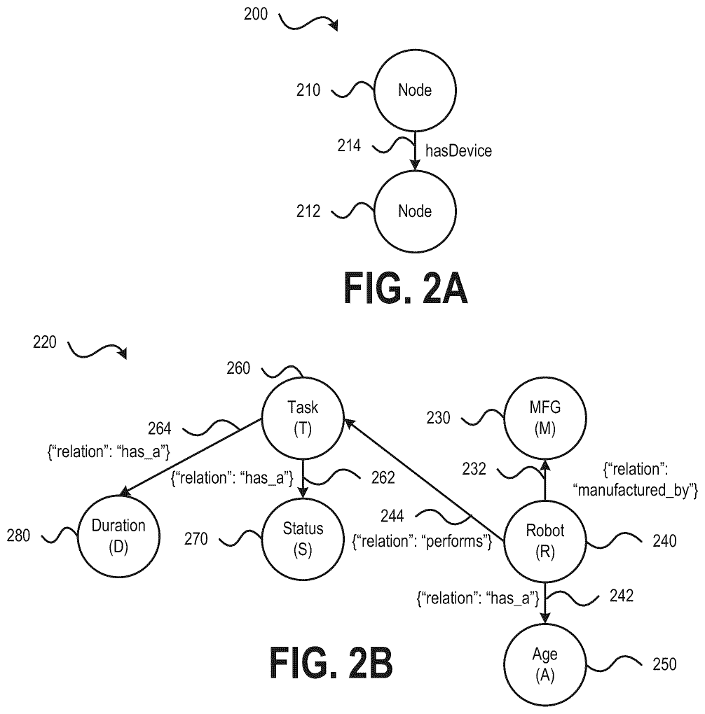

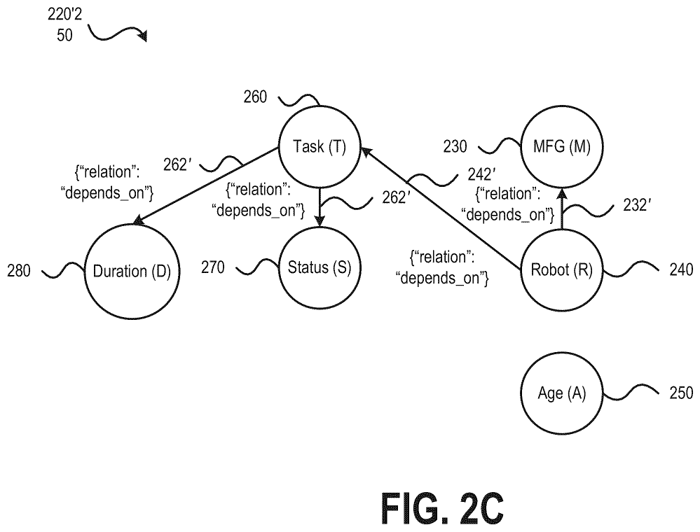

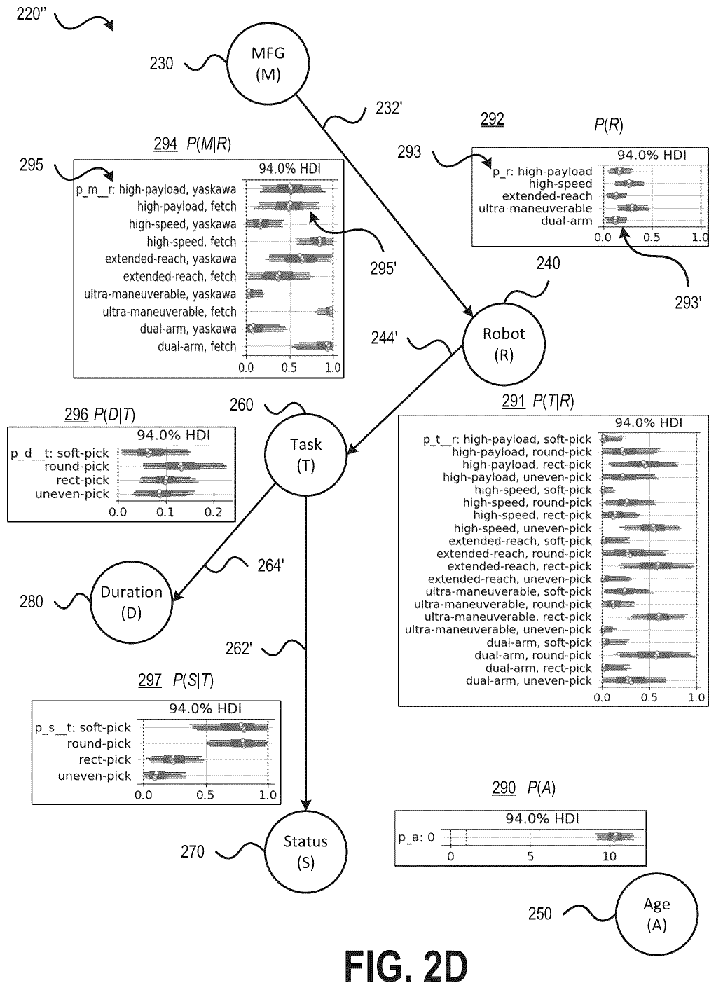

As described briefly above, the knowledge engine 122 provides functionality for generating digital twins. To illustrate, the ontology 102 may be provided to the knowledge engine 122 and used to create a digital twin based on the ontology 102. The digital twin may initially be created as a knowledge graph based on the object types, semantic relationships, and other information specified in the ontology 102. As an illustrative example and referring to FIG. 2A, a block diagram illustrating exemplary aspects of a knowledge graph in accordance with aspects of the present disclosure is shown as a knowledge graph 200. The knowledge graph 200 includes nodes 210, 212 connected via an edge 214. The nodes 210, 212 are digital representations of physical assets (e.g., physical locations, devices, machines, processes, etc.) identified in the ontology and different nodes may be associated with different node types based on properties derived from the ontology. To illustrate using the simplified example shown in FIG. 2A, node 210 represents a first node type—a physical location, such as a warehouse or production facility—and node 212 represents a second node type—an asset, such as robot, present in the physical location corresponding to the node 210. The edges of the knowledge graphs may be determined based on the ontology and may be used to formalize semantic relationships within the knowledge graph. For example, in FIG. 2A the edge 214 indicates a semantic relationship between the nodes 210, 212, namely, that the robot represented by the node 212 is located at the physical location represented by the node 210, as indicated by the label “hasDevice” associated with the edge 214 (e.g., the edge 214 indicates the location corresponding to the node 210 has a device corresponding to the node 212). It is noted that the edges of the knowledge graph may be defined such that they point from one node to another node (e.g., from node 210 to node 212) or from a node to data, and the particular node an edge points to may be determined based on the semantic relationship information included in the ontology (e.g., the ontology 102 of FIG. 1).

In addition to nodes representing assets, other types of nodes may be provided in a knowledge graph, such as nodes representing attributes (e.g., an age of a machine or robot represented in the knowledge graph), processes steps (e.g., tasks performed by a machine or robot represented in the knowledge graph), entities (e.g., a manufacturer of a machine or robot represented in the knowledge graph), or other types of nodes. As described above, these nodes may be connected to other nodes via edges. For example, the knowledge graph 200 could be generated to include a task node (not shown in FIG. 2A) that is connected to the node 212 representing a robot via an edge that points from the node 212 to the task node to indicate that the robot performs the task associated with the task node. Similarly, the knowledge graph 200 could be generated (e.g., by the knowledge engine 122) to include an attribute node (not shown in FIG. 2A) that is connected to the node 212 representing a robot via an edge that points from the node 212 to the attribute node to indicate that the robot has the attribute associated with the attribute node. Likewise, the knowledge graph 200 could be generated to include an entity node (not shown in FIG. 2A) that is connected to the node 212 representing a robot via an edge that points from the entity node to the node 212 to indicate that the robot was produced by the entity associated with the entity node.

Referring back to FIG. 1, while the knowledge engine 122 may enable creation of a digital twin in the form of a knowledge graph using the ontology 102 and the data, the knowledge graph-based instantiation of the ontology 102 may provide limited capabilities. As explained above, the computing device 110 includes the extension engine 124 to extend the knowledge graph-based digital twin to enable new types of analysis and use cases for which the digital twin may be utilized. To illustrate, while the description of FIG. 2A mentions that the knowledge graph generated from the ontology 102 may incorporate data, the types of data that may be incorporated from the ontology are often simplistic and may even be static (e.g., because ontologies provided to the computing device 110 may be based on industry standard ontologies). The extension engine 124 may be utilized to extend the knowledge graph to provide new capabilities, such as incorporation of new types of data (e.g., data that may not have been in the ontology 102 when first received by the computing device 110).

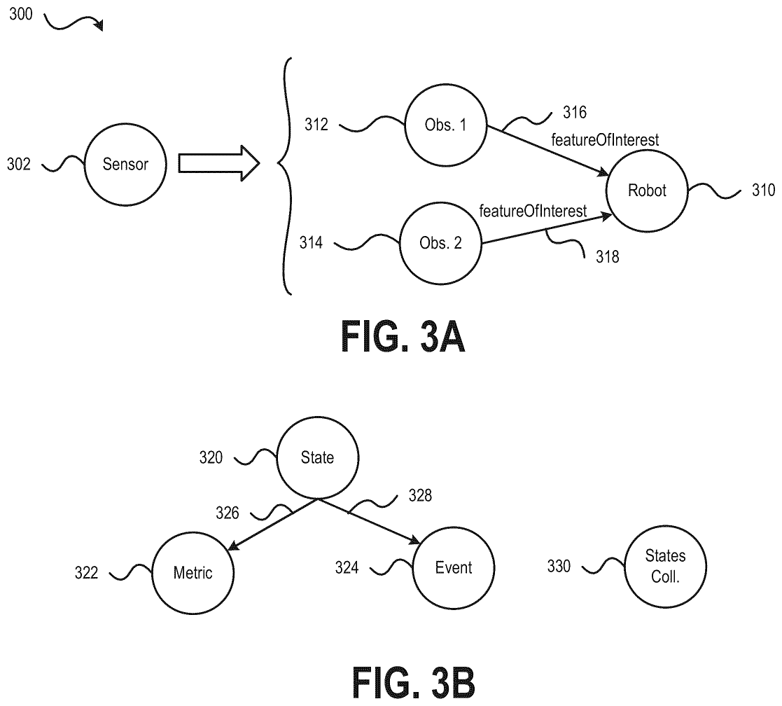

To incorporate additional data into the knowledge graph-based digital twins, the extension engine 124 may provide functionality for defining new node types into the ontology. As an illustrative and non-limiting example, time series data is one type of data that has been traditionally difficult to incorporate into digital twin applications due to scalability. In particular, time series data may include large amounts of data and such vast quantities of information may significantly increase the size of the knowledge graph, creating scaling difficulties and increasing the complexity of extracting meaningful information from the time series data using a digital twin. To address the scaling and querying challenges, the extension engine 124 may modify the ontology (or the knowledge graph directly) to include nodes supporting new types of data. To extend the ontology or knowledge graph to support new types of data the extension engine 124 may utilize one or more classes to introduce new nodes and edges within the knowledge graph and/or ontology. Additional details regarding the use of classes to extend the types of nodes and edges that may be incorporated into an instantiation of an ontology as a knowledge graph in accordance with the present disclosure are described in more detail below with reference to FIG. 3A.

By enabling extension of digital twins (e.g., knowledge graphs) to support new types of data, the extension engine 124 enables digital twins to be customized or tailored to support many different use cases and types of analysis, which is a major advantage over existing digital twin platforms and tools that are static (i.e., statically designed to support specific use cases and data). In addition to enabling customization of the data and components (e.g., nodes and edges) of the digital twin, the extension engine 124 may also support additional extensions of digital twins. For example, due to the ability to customize the types of data that may be supported by the digital twin, the extension engine 124 may enable the digital twin to be extended to provide probabilistic reasoning and decision making under uncertainty capabilities. As part of the extension process, the extension engine 124 may also provide functionality for converting components of the digital twin from one type of component to another type of component. For example, a data node may be changed to a variable node and edges specifying semantic relationships derived from the ontology 102 may be converted to edges representing statistical dependencies and/or information edges (e.g., edges that identify information upon which a variable node depends). The functionality provided by the extension engine 124, which has been briefly described above, enables a digital twin to be customized to incorporate new types of data, which enables the digital twin to be used for new types of analysis and evaluation designed in an ad hoc manner and enabling digital twins to be rapidly created in an ontology driven manner and then customized or tuned in a manner that supports new forms of analysis and understanding to be obtained from the digital twin(s). These capabilities represent a significant improvement to systems (e.g., platforms and tools) for generating digital twins, which presently are designed to support specific real world counterparts and are generated in a static manner that does not support other instances of the real world counterpart (e.g., a digital twin designed for an engine manufactured by a first manufacturer using prior platforms or tools cannot be used to evaluate an engine manufactured by a second manufacturer despite both real world counterparts being engines) and do not support tuning of the digital twin to provide new understanding or analysis (e.g., existing digital twin platforms are designed with static capabilities for a particular analysis use case or use cases).

As a non-limiting example of the above-described functionality and with reference to FIG. 2B, a block diagram of a knowledge graph in accordance with aspects of the present disclosure is shown as a knowledge graph 220. As explained above, the knowledge graph 220 may be generated by the knowledge engine 122 based on an ontology, such as the ontology 102 of FIG. 1. As shown in FIG. 2, the knowledge graph 220 includes nodes 230, 240, 250, 260, 270, 280, where node 230 represents a manufacturer (M), node 240 represents a robot (R), node 250 represents an age (A) (i.e., an attribute), node 260 represents a task (T), node 270 represents a status (S), and node 280 represents a duration (D). The knowledge graph 220 also includes a series of edges 232, 242, 244, 262, 264 connecting different pairs of the nodes 230, 240, 250, 260, 270, 280. The edges 232, 242, 244, 262, 264 of the knowledge graph 220 indicate semantic relationships among the nodes 230, 240, 250, 260, 270, 280. For example, edge 232 points from the node 240 (i.e., the robot) to the node 230 (i.e., the manufacturer) to indicate the relationship between nodes 230, 240 is that the robot was manufactured by the manufacturer. Similarly, the edge 242 points from node 240 (i.e., the robot) to the node 250 (i.e., the age attribute) to indicate the relationship between nodes 240, 250 is that the robot has an age, and the edge 244 points from node 240 (i.e., the robot) to the node 260 (i.e., the task) to indicate the relationship between nodes 240, 250 is that the robot performs the task. Likewise, the edge 262 points from node 260 (i.e., the task) to the node 270 (i.e., the status) to indicate the relationship between nodes 260, 270 is that the task has a status, and the edge 264 points from node 260 (i.e., the task) to the node 280 (i.e., the duration) to indicate the relationship between nodes 260, 280 is that the task has a duration.

Referring back to FIG. 1, as part of the process for creating a knowledge graph (e.g., the knowledge graph 220 of FIG. 2B), the functionality of the extension engine 124 may be leveraged to incorporate data from one or more data sources 150. For example, the data sources 150 may include sensors or devices 152 (hereinafter “sensors 152”), systems 154, or other sources of data (e.g., the database(s) 138, etc.). The sensors 152 may include Internet of things (IoT) devices, temperature sensors, motion sensors, weight sensors, pressure sensors, network traffic sensors, reading devices (e.g., magnetic card reader devices, radio frequency identified (RFID) devices, chip card readers, or other types of devices configured to read information from a device scanned in proximity to the reading device(s)), fuel sensors, accelerometers, gyroscopes, or other types of sensors configured to detect information of interest with respect to a real world counterpart. In addition, the sensors 152 may include other types of devices that may provide information of interest for use in analysis and understanding using a digital twin, such as controllers, navigation systems, communication devices, or other types of devices that may collect or generate information related to operations or functioning of the real world counterpart of a digital twin. Furthermore, the systems 154 may include enterprise resource planning (ERP) systems or other types of systems that may contain information related to the real world counterpart corresponding to a digital twin being created using the system 100.

As can be appreciated from the foregoing, information pertaining to a real world counterpart of a digital twin can include many different data sources 150 and types of data. Rather than attempting to design a digital twin generation platform that is specifically configured for specific data types and data sources, the present disclosure provides a data ingestion engine 120 that provides functionality for obtaining or receiving information from a variety of data sources and storing the data in the one or more database 118. Once stored, the extension engine 124 may be used to extend the knowledge graph (e.g., the knowledge graph 220 of FIG. 2B) to incorporate the data obtained by the data ingestion engine 120. For example, data obtained by the data ingestion engine 230 in connection with the knowledge graph 220 of FIG. 2B may include information associated with one or more types of robots corresponding to node 240 (e.g., high-speed robots, ultra-maneuverable robots, high-payload robots, extended-reach robots, etc.), the manufacturer of each type of robot, the age of the robots, tasks that can be performed by each different robot, information regarding a duration for instances of each robot performing a corresponding task, information regarding a status of each task (e.g., completed/not completed, success/fail, etc.), or other types of information.

It is to be understood that the exemplary types of information described above in connection with the information represented by the knowledge graph 220 of FIG. 2B that may be collected by the data ingestion engine 120 have been provided for purposes of illustration, rather than by way of limitation and that other types of data may be ingested into the computing device 110 by the data ingestion engine 120 in connection with the creation of digital twins involving other types of real world counterparts. For example, a manufacturing facility may be represented as a digital twin and the data ingestion engine 120 may obtain information associated with various aspects of the manufacturing process, such as the order in which the manufacturing process is performed, the materials and/or machinery or equipment involved in each stage of the manufacturing process, the sources of the materials, the storage locations of the materials, operations performed by the machinery or equipment during the manufacturing process, packaging of the products once produced, or any other types of steps, processes, or features that may be needed to model the manufacturing process as a digital twin.

As another example, the computing device 110 may also enable digital twins to be created in a system of systems-type manner whereby multiple digital twins are created and combined into a digital twin of digital twins, such as a digital twin of a process for producing the materials, a materials acquisition process, a manufacturing process, shipping or logistics process and/or system, and other aspects of the life cycle from producing materials, to manufacturing products, to delivering the products to end users or consumers. Such system of systems-type digital twins may be used to represent complex workflows, processes, equipment, and the like, thereby enabling the creation of digital twins for entire ecosystems, which is a capability that is currently not available using existing digital twin platforms and tools. During creation of such complex digital twins as those described above, many different types of data may be obtained for incorporation into knowledge graphs generated by the knowledge engine 122.

In some aspects, the functionality of the data ingestion engine 120 may be provided via a GUI that enables a user to specify the data sources 150 of interest (i.e., which data sources of the data sources 150 from which to obtain data for a digital twin), the types of data to be obtained, and a frequency at which the data should be obtained. For example, the knowledge graph 220 of FIG. 2B relates to digital twin of a robot that performs tasks. In the context of the digital twin (e.g., the knowledge graph), the robot may be any type of robot and the tasks performed by the robot may vary according to a particular robot of interest. In this manner the digital twin may be independent of any specific real world counterpart represented by the knowledge graph. To facilitate use of the digital twin for analysis and understanding of the real world counterpart, data associated with a particular real world counterpart or multiple real world counterparts (e.g., one or more robots) may be incorporated into the knowledge graph 220.

To obtain the data, the user may utilize the interactive elements of the GUI associated with the functionality of the data ingestion engine 120 to specify one or more data sources of the data sources 150 from which the data ingestion engine 120 should obtain the data. In some aspects, the data may be initially provided as bulk data (e.g., historic data associated with one or more robots) and may be uploaded to the computing device 110 via the data ingestion engine 120. Additionally, the data ingestion engine 120 may also be configured to periodically retrieve additional data from the data sources 150. For example, the GUI may enable the user to specify a frequency with which the data ingestion engine 120 updates the data associated with the digital twin. Once specified, the data ingestion engine 120 may periodically access the configured data sources to retrieve updated data for incorporation into the knowledge graph 220. Once the data is incorporated into the knowledge graph, the digital twin may be used to analyze and evaluate one or more robots, their behaviors, and the like depending on the data incorporated into the knowledge graph. In this manner, a digital twin created using the computing device 110 can be used to model and analyze multiple different real world counterparts sharing similar characteristics.

While incorporation of some of the data may be straightforward, other types of data may be more complex, such as time-series data. Incorporation of time series data into a digital twin is more complex as such data significantly increases the size of the knowledge graph and can degrade performance of the digital twin. To facilitate integration of time series data, the functionality of the extension engine 124 may be utilized. For example, the extension engine 124 provides functionality for defining extensions of the knowledge graph, such as enabling new types of data (e.g., time series data) to be incorporated into the knowledge graph. For time series data, the functionality of the extension engine 124 may enable a set of classes to be defined, where the classes control a structure (a series of nodes and corresponding edges) for incorporating time series data into the knowledge graph.

To illustrate and referring to FIG. 3A, a block diagram illustrating a process for obtaining time series data into a digital twin in accordance with the present disclosure is shown as a process 300. As shown in FIG. 3, the process 300 involves a sensor 302 and a robot 310. In an aspect, the sensor 302 may be one of the sensors 152 of FIG. 1 and the robot 310 may correspond to the robot(s) represented by the node 240 of FIG. 2B. The sensor 152 may be configured to monitor one or more features of interest for the robot 310 and as a result of the monitoring, the sensor 152 may make observations regarding the features of interest. For example, in FIG. 3A, an observation 312 and an observation 314 are shown. The observation 312 may correspond to a measurement or other information characterizing the feature of interest at a first point in time 316 and the observation 314 may correspond to a measurement or other information characterizing the feature of interest at a second point in time 318. As can appreciated from the foregoing, over time the sensor 302 may make a large number of observations with respect to the feature of interest for the robot 310.

Each of the observations by the sensor 302 may be datapoint and a time series of data may be made up of multiple datapoints. For example, suppose the feature of interest is the battery charge percentage for the robot 310. In the first observation 312 the feature of interest (e.g., the battery charge percentage) may be 25%, in the second observation 312 the feature of interest (e.g., the battery charge percentage) may be 18%, and in other observations the feature of interest may have other values. In the context of the present application, the exemplary time series data described above may be considered a metric-stated another way, one form of time series data that may be used to extend a digital twin is metrics, which are timestamped observations (e.g., an observation with metadata about the time frame in which the observation occurred).

Another form of time series data that may be used to extend digital twins via the functionality provided by the extension engine 124 is events, which may be predefined observation instances. For example, an event that may be used to extend the knowledge graph 220 of FIG. 2B is an operational status of the robot represented by the node 240. Such events may include observations that the robot has overheated, the robot is obstructed, the robot's battery charge level has reached critical status, and the like. Using the functionality of the extension engine 124, a user may define events that may be detected by the sensors 152 and incorporated into the digital twin (i.e., the knowledge graph 220). Like the metrics described above, the events may be timestamped to associate detected events with a period of time when the events occur.

Additionally, the extension engine 124 may provide functionality for creating collections based on the observations (e.g., metric observations and/or events observations), where the collections are groupings of observations. For example, suppose that the sensors 152 include a first sensor and a second sensor. Each of the sensors may capture metrics (or observations) associated with the robot 310 and information associated with the captured metrics (or events) may be obtained by the data ingestion engine 120. The extension of the digital twin to incorporate such time series data may utilize one or more collections to efficiently incorporate the metrics (or events) into the digital twin. The collections may be organized based on a design specification configured by a user. For example, the collections may include a first collection corresponding to the metrics (or events) measured or detected by the first sensor and a second collection corresponding to the metrics (or events) measured or detected by the second sensor. As another example, the collections may be organized based on periods of time such that a first collection incorporates the metrics (or events) measured or detected by the first and second sensors for a period of time (e.g., a day, 2 days, 3 days, 1 week, etc.). Organizing the data obtained by the data ingestion engine 120 from the sensors 152 into collections reduces the number of nodes added to the knowledge graph (e.g., the knowledge graph 220 of FIG. 2B) to incorporate time series data, which may reduce the impact of additional data being incorporated into the digital twin and improve performance as compared to not using collections.

To facilitate the use of collections of time series data with the knowledge graph, the functionality of the extension engine 124 may be used to define a set of classes that serve to provide a data structure for the observations to be recorded to the knowledge graph and a mechanism to incorporate relationships between the time series data and the digital twin. To illustrate and referring to FIG. 3B, a block diagram illustrating examples of a class hierarchy for incorporating time series data into a digital twin in accordance with aspects of the present disclosure are shown. As shown in FIG. 3B, the class hierarchy may include a plurality of classes 320, 322, 324, 330. The class 320 represents a state class, the class 322 represents a metric class, and the class 324 represents an event class. In such an arrangement, the classes 322, 324 represent derived classes. For example, arrow 326 connecting the state class 320 to the metric class 322 indicates the metric class 322 is derived from the state class 320, and arrow 328 connecting the state class 320 to the event class 324 indicates the event class 324 is derived from the state class 320. As derived classes, the metric class 322 and the event class 324 inherit features and functions of the state class 320 and may also add additional features and functionality to the base class (e.g., the state class 320). Additionally, FIG. 3B shows a states collection class 330. The states collection class 330 may be used to create collections based on objects established using the metrics class 322 and the events class 324. The state class 320 may configured to associate objects created using the data obtained by the data ingestion engine 120 a portion of the real world counterpart represented by the digital twin. As a non-limiting example, exemplary pseudocode for the classes 320, 322, 324, 330 may be given as:

State {
isStateFor exactly one owl:Thing;
belongsToCollection only StatesCollection
}
Metric {
hasTimeInterval exactly 1 time:DateTimeInterval;
isMeasuring exactly 1 PointOfInterest;
isMetricType exactly 1 MetricType;
value exactly 1 xsd:float
}
Event {
hasTimeInstant exactly 1 time:Instant;
isEventType exactly 1 EventType
}
StatesCollection {
hasMetricInstance only Metric;
hasEventInstance only Event
}

In the exemplary pseudocode above, the state class 320 associates an instance of the state class 320 (or one of the classes 322, 324 derived from the state class 320) with a portion of the real world counterpart represented by the digital twin. Additionally, the state class includes features to restrict an instance of the state class 320 (or a derived class) to a particular instance of the states collection class 330. Similarly, the metric class 322 specifies a time interval over which a metric is measured or obtained, a number of points of interest to be measured during the time interval, assign a type to the metric(s) being measured, and specify a data type to the data associated with the metric. Similarly, the event class 324 specifies a number of times an instance of an event occurs (e.g., 1 time, 2 times, etc.) and an event type (e.g., criteria for detecting the event). The states collection class 330 specifies whether a collection includes metrics or events (e.g., associates a collection of observations with a series of metrics over time or a series of events over time). Using the hierarchy of classes described above, the extension engine 124 may enable time series data to be incorporated into a digital twin as a series of collections, where the collections may be added as nodes to the knowledge graph representing the digital twin being designed.

By incorporating collections of time series data into the knowledge graph, the extension engine 124 enables new types of information to be derived from the digital twin, such as information quantifying relationships between different pairs of nodes. For example and referring to FIG. 2C, a block diagram illustrating a knowledge graph having time series data incorporated therein in accordance with aspects of the present disclosure is shown as a knowledge graph 220′. The knowledge graph 220′ incorporating the time series data (e.g., as one or more collections) may enable new insights to be captured from the digital twin, such as dependencies that indicate how different nodes are connected, rather than just that nodes are connected (i.e., semantic relationships). For example, unlike the knowledge graph 220 of FIG. 2B, the edges 232′, 242′, 262′, and 264′ do not include an edge between node 240 and node 250. This is because edges of the knowledge graph 220 of FIG. 2B represent semantic relationships while the edges of the knowledge graph 220′ represent statistical dependencies. Since the age (A) associated with the node 250 is not statistically dependent on the robot (R) represented by the node 240, the knowledge graph 220′ does not include an edge between nodes 240, 250. Additionally, the edges 232, 242, 262, 264 indicate non-dependency-type relationships between the different pairs of nodes connected by these edges (e.g., “manufactured by”, “has_a”, “performs”) while the edges 232′, 242′, 262′, 264′ indicate statistical dependencies (e.g., “{‘relation’: ‘depends_on’}” for each of the edges 232′, 242′, 262′, and edge 264′ indicates that the variable (R) depends on the variable ( ) (e.g., robots may be produced by different manufacturers). Similarly, the edge 242′ indicates that the task (T) associated with node 260 depends on the robot (R) associated with the node 240 (e.g., performance of a particular task depends on the robot since different robots can perform different tasks).

It is noted that the exemplary classes and subclasses described above with respect to incorporating time series data have been provided for purposes of illustration, rather than by way of limitation and that classes and subclasses may also be defined to support incorporation or utilization of other types of data with digital twins generated in accordance with the present disclosure. For example, the extension engine 124 may be used to define classes to support incorporation of hierarchical data or other types of data into a digital twin. Thus, it should be understood that the use of classes and subclasses, as well as collections, may enable digital twins to be created and extended to support various types of complex data and/or large sets of data in a manner that does not degrade performance of the digital twin and its supported analytics.

Incorporation of new types of data into the knowledge graph by the data ingestion engine 120 and the extension engine 124 may also enable further extensions to be performed. For example, a knowledge graph generated in accordance with the present disclosure may be extended by the extension engine 124 by converting the knowledge graph into a probabilistic graph model that includes probability distribution information for the real world counterpart represented by a digital twin. To extend the knowledge graph 220′ in this manner, the extension engine 124 may treat each node of the knowledge graph as a random variable (e.g., variables {A, R, M, T, S, D, . . . } in FIGS. 2B, 2C) representing a probability distribution for each variable. The probability distributions for each variable describes the possible values that a corresponding random variable can take and a likelihood (or probability) of the random variable taking each possible value. To obtain the probability distributions, the extension engine 124 may utilize Bayesian learning to derive a joint distribution for the knowledge graph based on the random variables and available data (e.g., data obtained by the data ingestion engine 120 from the data sources 152 and incorporated into the knowledge graph by the extension engine 124). Exemplary aspects of converting a knowledge graph into a probabilistic graph model are described in commonly owned U.S. patent application Ser. No. 17/681,699, filed Feb. 25, 2022, and entitled “SYSTEM FOR PROBABILISTIC REASONING AND DECISION MAKING ON DIGITAL TWINS,” the contents of which are incorporated herein by reference.

To facilitate the conversion of the knowledge graph-based digital twin to a probabilistic graph model-based digital twin, the extension engine 124 may provide a GUI that enables a user (e.g., a user of the computing device 130 of FIG. 1) to specify a type for each distribution associated with the random variables. The type of distribution to be associated with each random variable may also be provided by a domain expert and incorporated directly into the ontology. As a non-limiting example of associating distribution types to random variables, in probability theory Poisson distributions express the probability of a given number of events occurring in a fixed interval of time or space independent of the time since the last event. Since the age of a robot advances at a constant rate independent of the time a last change in age occurred, the user may associate the Poisson distribution type with the age variable (A). As another example, categorical distributions describe the possible results of a random variable that can take on one of K possible categories. The user may associate the categorical distribution type to the variables M, R, T since the probabilistic graph model may represent an environment (e.g., the environment defined in the ontology from which the knowledge graph was generated) where many different types of robots are present, each type of robot manufactured by a particular manufacturer and capable of performing a defined set of tasks, all of which define a set of K possible categories for M, R, T, respectively (i.e., a set of K manufacturer categories, a set of K robot categories, and a set of K task categories). Similarly, a Bernoulli distribution represents the discrete probability of a random variable which takes on the value of 1 with probability p and the value of 0 with probability q=1−p (i.e., success or failure). Since the status variable (S) indicates whether the task was performed successfully or failed, the user may associate the Bernoulli distribution type with the status variable (S). The user may assign the exponential distribution type to the duration parameter (D), which represents the amount of time taken to perform a task, because exponential distributions represent the probability distribution of the time between events. It is noted that the exemplary variables, probability distributions, and distribution types described above have been provided for purposes of illustration, rather than by way of limitation and that probabilistic graph models generated in accordance with the present disclosure may utilize other distributions, distribution types, and variables depending on the particular real world counterparts being represented by the probabilistic graph model generated in accordance with the concepts disclosed herein.

As can be appreciated from the foregoing, conversion of a knowledge graph with embedded data into a probabilistic graph model may utilize many different types of data and different types of distributions. By providing the ability to create classes and subclasses, such as the classes 320, 330 and subclasses 322, 324 derived from the class 320, the extension engine 124 may ensure that data incorporated into a knowledge graph to extend the knowledge graph's capabilities is configured appropriately for use with different types of distribution analysis. Thus, the classes/subclasses used to incorporate data into the knowledge graph may be defined in a manner that streamlines and supports conversion of the knowledge graph to a probabilistic graph model by ensuring the data is incorporated in an appropriate format for the probability distribution type associated with each random variable.

An example of a probabilistic graph model generated in accordance with the present disclosure is shown in FIG. 2D, which is a block diagram illustrating a digital twin providing probabilistic reasoning capabilities in accordance with the present disclosure. The digital twin shown in FIG. 2D represents a digital twin 220″ in the form of a probabilistic graph model obtained by solving the joint distribution of the knowledge graph 220′ based on incorporation of time series data using the functionality provided by the extension engine 124 of FIG. 1. To illustrate, the joint distribution may be represented as:

P(A,R,M,T,D,S)=P(A)P(R)P(M|R)P(T|R)P(D|T)P(S|T) (Equation 1)

where P(A) is the probability distribution for the variable A, P(R) is the probability distribution for the variable R, P(M|R) is the probability distribution for the variable M|R representing the statistical dependency between manufacturers (M) and robots (R), P(T|R) representing the statistical dependency between tasks (T) and robots (R), P(D|T) representing the statistical dependency between duration (D) and tasks (T), and P(S|T) representing the statistical dependency between tasks (T) and status (S). Using the Bayesian learning processes mentioned above, approximations of any unknown parameters may be learned through simulation using a generative program.

As a non-limiting example, the generative program may be generated via functionality of the extension engine 124 using a GUI and may include a series of deterministic and probabilistic statements, such as:
P(A)˜Gamma (1, 1)
age˜Poisson (p(A))
p(R)˜Dirichlet(1)
robot˜Categorical (p(R))
p(M|R)˜Dirichlet (0.5)
manufacturer˜Categorical (p(M|R=robot))
p(T|R)˜Dirichlet (0.25)
task˜Categorical (p(T|R=robot))
p(D|T)˜Gamma (1, 1)
duration˜Exponential (p(D|T=task))
p(S|T)˜Beta (1, 1)
status˜Bernoulli (p(S|T=task))
   In the exemplary statements above, the deterministic statements are those statements including an assignment (e.g., “=”) and the remaining statements represent probabilistic statements. The generative program provides a model that may be used to estimate or approximate the unknown parameters. For example, the probabilistic modelling and optimization engine may configure the generative program with a set of guessed parameters and run a simulation process to produce a set of simulation data. The set of simulation data may then be compared to observed data to evaluate how closely the simulation data obtained using the guessed parameters matches or fits actual or real world data. This process may be performed iteratively until the simulated data matches the actual data to within a threshold tolerance (e.g., 90%, 95%, etc.). It is noted that as the set of data grows larger, the ability to estimate or guess the parameters may improve. Thus, the above-described learning process may be periodically or continuously performed and the accuracy of the estimations of the unknown parameters may improve as the set of data grows larger.

Once the unknown parameters are obtained, the probability distributions P(A), P(R), P(M|R), P(T|R), P(D|T), P(S|T) having the approximated parameters may be embedded within the probabilistic graph model to produce the digital twin 220″. As shown in FIG. 2D, embedding the probability distributions into the digital twin 220″ may associate the probability distributions with an edge or a node. In particular, the probability distributions are associated with edges when the probability distributions correspond to statistical dependencies between a pair of nodes and probability distributions associated with independent random variables may be associated with nodes. For example, in FIG. 2D the probability distribution P(A) 290 is associated with the node 250 and the probability distribution P(R) 292 is associated with the node 240, while the probability distributions P(M|R) 294, P(T|R) 291, P(D|T) 296, P(S|I) 297 are associated with the edges 232′, 244′, 264′, and 262′, respectively.

Once the probability distributions having the guessed or estimated parameters are added, the digital twin 220″ may be queried to obtain information that would otherwise not be available using a knowledge graph, such as the knowledge graph 220 of FIG. 2B or the knowledge graph 220′ of FIG. 2C. For example, the digital twin 220″ represents a model of an environment where different robots performs tasks. The probability distribution P(R) 292 includes all possible values 293 of the variable R (e.g., the variable R may take on values of “high-payload”, “high-speed”, “extended-reach”, “ultra-maneuverable”, and “dual-arm”) and each possible value may have an associated probability 293′. Similarly, the probability distribution P(M|R) 294 includes all possible values 295 for the statistical dependency (represented by edge 232′) for the variables M and R (e.g., the possible combinations for the variables M, R may include “high-payload, yaskawa”, “high-payload, fetch”, “high-speed, yaskawa”, “high-speed, fetch”, “extended-reach, yaskawa”, “ultra-maneuverable, yaskawa”, “ultra-maneuverable, fetch”, “dual-arm, yaskawa”, and “dual-arm, fetch”) and each possible value may have an associated probability 295′. The probability distribution P(A) 290 may follow a structure similar to the probability distribution P(R) 340, but provide all possible values and their corresponding probabilities for the random variable A; the probability distributions P(T|R) 291, P(D|T) 296, P(S|I) 297 may follow a structure similar to the probability distribution P(M|R) 294, but provide all possible values and their corresponding probabilities for the statistical dependencies associated with their random variable pairs (e.g., T|R, D|T, S|T, respectively).

The probability distributions obtained by extending knowledge graphs to probabilistic graph models enable creation of digital twins that provide new capabilities and insights that facilitate new types of analysis and understanding to be obtained with respect to the real world counterparts represented by the digital twins, such as probabilistic reasoning or analysis. For example, a query P(M|S=success) may be defined and used to analyze the question: What is the best performing manufacturer? Executing the query against the probabilistic graph model representing the digital twin 220″ using the joint distribution P(A, R, M, T, S, D) returns a distribution that indicates which manufacturer has a higher probability of successfully completing a task as compared to other manufacturers. As another example, a query P(D|R dual alarm, T=softpick) may be used to analyze the question: What is the expected duration of a soft object pick performed by a dual arm robot? Executing the query against the probabilistic graph model represented by the representing the digital twin 220″ using the joint distribution P(A, R, M, T, S, D) returns a distribution that indicates the expected duration (e.g., in units of time) probabilities for performing the task and may enable insights into what the range of probabilities is for the duration (e.g., what duration has the highest probability, what duration has the lowest probability, and the probabilities of intermediate durations). It is noted that this query could be modified to evaluate the expected duration of performing other types of tasks using a dual-arm robot by changing the task variable T and/or may be modified to evaluate the expected duration of performing the soft object pick using another type of robot (i.e., other than a dual-arm robot) by changing the variable D|R. As yet another example, a query P(S|R high-speed, T=round-pick) may be used to analyze the question: What is the likelihood of task failure when using a high-speed robot to pick round objects? Executing the query against the probabilistic graph model representing the digital twin 220″ using the joint distribution P(A, R, M, T, S, D) returns a distribution that indicates whether the likelihood of success is greater than the likelihood of failure. It is noted that the exemplary queries described above have been provided for purposes of illustrating the new types of insights that may be obtained from digital twins generated in accordance with the concepts disclosed herein. However, it should be understood that other types of queries and insights may be obtained by applying similar querying techniques to digital twins representing other types of real world counterparts in accordance with aspects of the present disclosure.

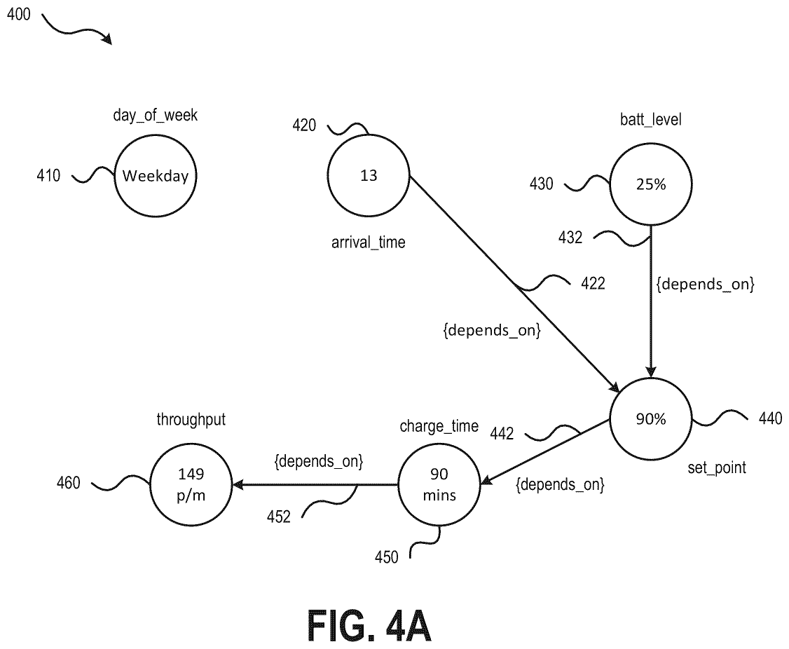

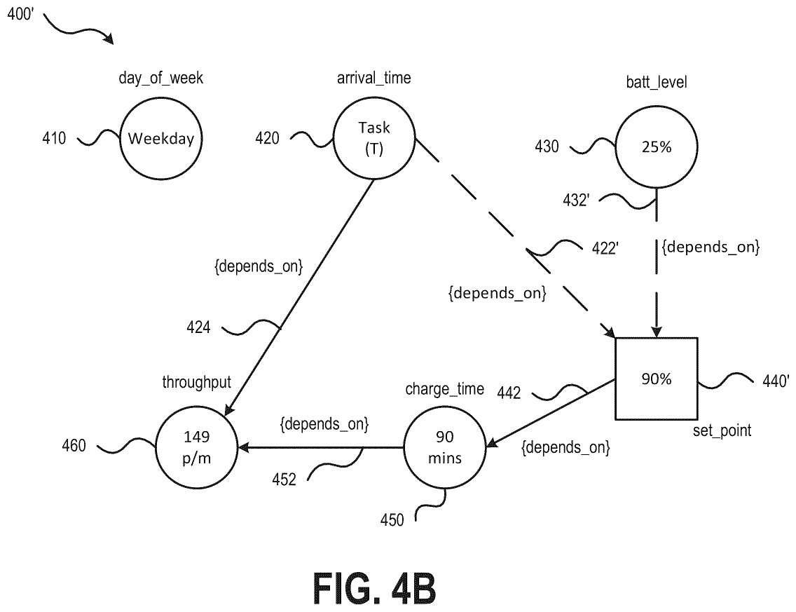

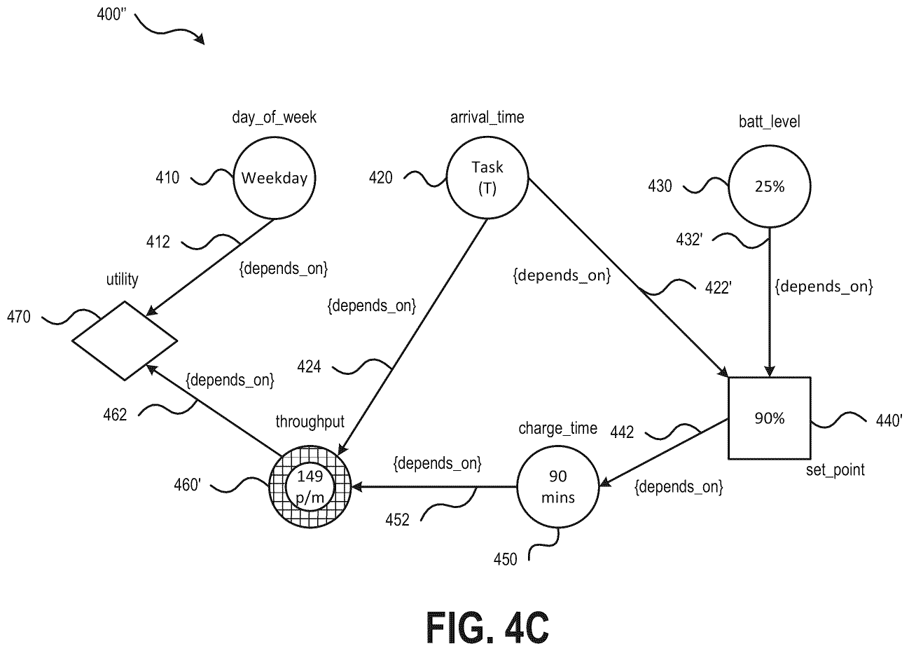

The generation of probabilistic graph model-based digital twins enables further extensions to be achieved to provide additional capabilities and insights. For example and referring to FIG. 4A, a block diagram of digital twin generated in accordance with aspects of the present disclosure is shown as a probabilistic graph model 400. The probabilistic graph model 400, which represents one form of digital twin that may be generated using the functionality of the extension engine 124 of FIG. 1 and the concepts described above, associated with a use case involving a robot that is used to unload trucks arriving at a loading dock is shown. The probabilistic graph model 400 includes nodes 410, 420, 430, 440, 450, 460, and various ones of the nodes 410, 420, 430, 440, 450, 460 are connected via edges 422, 432, 442, 452. The node 410 is associated with the weekday (e.g., the trucks may arrive for unloading on different days of the week); the node 420 is associated with the set of possible arrival times for the truck(s); the node 430 is associated with the battery level of the robot; the node 440 is associated with a set point indicating a battery level percentage (%) at which the robot stops charging; the node 450 is associated with a charge time (e.g., the amount of time the robot may operate for a given charge level of the battery); and the node 460 is associated with throughput of the robot (e.g., how many items per unit of time can the robot unload, such as items per minute/hour, etc.). The probabilistic graph model 400 may have been generated by instantiating an ontology, such as the ontology 102 of FIG. 1, as a knowledge graph using the knowledge engine 122, extending the knowledge graph to incorporate additional data, such as time series data, and then solving the joint distribution of the variables represented by the nodes and/or edges using the extension engine 124, as described above.

As described above, digital twins represented by probabilistic graph models may be queried to extract information about the real world counterpart corresponding to the digital twin that may not be readily obtained from a knowledge graph alone or from the data used to extend the knowledge graph. While the examples described above are primarily related to queries designed to extract statistical inferences or other types of information about the domain represented by the probabilistic graph model, an additional capability provided by the probabilistic graph model-based digital twins generated in accordance with the present disclosure is the ability to use the probabilistic graph models to solve optimization problems despite uncertainty, which is a type of analysis that digital twins designed using presently available digital twin platforms and tools cannot provide.

To illustrate within the context of the scenario represented by the digital twin corresponding to probabilistic graph model 400, a user may utilize the functionality of the extension engine 124 to extend the probabilistic graph model 400 to enable solving optimization problems, such as optimization of the question “How much should the robot charge the battery?” This question represents an optimization problem because there is a tradeoff between under-charging the battery and over-charging the battery. In particular, if the battery is under-charged the robot may run out of battery power and need to recharge during peak demand and if the battery is over-charged there is a risk demand will arrive during charging. Moreover, this problem also has uncertainty since the time when the demand may arrive is unknown, although the probabilistic graph model may be used to derive a distribution for the arrival of the demand.

To facilitate extension of the probabilistic graph model 400 to support solving optimization problems, functionality of the extension engine 124 may be utilized to identify variables for which optimization may be desirable and nodes corresponding to variables that may be optimized may be converted to a new node type. For example and referring to FIG. 4B, a block diagram of an extended probabilistic graph model in accordance with aspects of the present disclosure, is shown as a probabilistic graph model 400′. The probabilistic graph model 400′ may be generated by extending the probabilistic graph model 400 of FIG. 4A, where the extension includes converting the set_point node 440 to a different node type, namely, a decision node 440′. While the node 440 of FIG. 4A represents a variable within the overall joint distribution of the probabilistic graph model 400, which may be associated with a set of possible values and probability distributions associated with each value of the set of possible values, as described above with reference to FIG. 3D, the decision node represents a parameter that may be used to target outcomes for optimization using queries. Stated another way, rather than simply representing a set of data and probabilities, the decision node 440′ (or any other decision node) represents an optimization parameter within the digital twin.

Additionally, the extension engine 124 may also convert one or more edges of the probabilistic knowledge graph model to new node types for use in supporting the decision nodes. For example, the extension engine 124 may provide functionality for converting the edges 422, 432 shown in FIG. 4A from edges representing statistical dependencies to information edges 422′, 432′, respectively. In the context of the digital twin shown in FIG. 4B, the information edges 422′, 432′ indicate where the uncertainty lies with respect to the optimization problem, namely, when demand for use of the robot will arrive (e.g., node 420) and the robot's current battery level (e.g., node 430). These nodes represent uncertainty because it is unknown when the demand will arrive and the robot's battery charge level could be at any value between depleted and full when the demand does arrive.

In addition to defining one or more decision nodes, the functionality of the extension engine 124 may also be used to convert nodes to other types of nodes and/or add one or more new nodes to the probabilistic graph model 400 to support solving optimization problems. For example and referring to FIG. 4C, a block diagram of an extended probabilistic graph model in accordance with aspects of the present disclosure is shown as a probabilistic graph model 400″. The probabilistic graph model 400″ may be obtained using the functionality of the extension engine 124 of FIG. 1 by extending the probabilistic graph model 400′ (or the probabilistic graph model 400) to include a utility node 470 and a target node 460′. The target node 460′ may correspond to the target outcome of the optimization, which, in the example of FIG. 4C is maximizing throughput, and utility node 470 represents derived data obtained from the data embedded in the knowledge graph or probabilistic graph model 400. To illustrate, the utility node 470 is connected by edges 412, 462 to the nodes 410, 460′, respectively. The edges 412, 462 indicate the data represented by the utility node “depends_on” the nodes 410, representing the day of the week, and the node 460′, representing throughput. Thus, the utility node 470 may represent a set of data derived based on the dependencies of the utility node, such as the data corresponding to both the node 410 and the node 460′. In the context of the example shown in FIG. 4C, the utility node 470 may represent probabilistic relationships between days of the week and throughput.

Once the decision, utility, and target nodes have been created, the optimization problem may be defined. In the example of FIG. 4C, the optimization problem seeks to find a value of the set point (e.g., the decision node 430′) that maximizes the expected value of the utility node 470. This optimization problem may be expressed as:
Given a Decision node (i.e., battery set point) A={a₁ . . . , a_{K}}
And a Target Outcome node (i.e., throughput) X={x₁, . . . , x_{N}})
And a Probabilistic Outcome Model (i.e., the probabilistic graph model 700) P(X|A)
And a Utility function U: X→ [symbol]
Applying the principle of Maximum Expected Utility, a decision a* may be chosen that maximizes the expected utility:

$${EU}_{{δ}_{A}} = {\sum }_{x , a} P ( X = x , A = a ) U ( x , a ) ,$$

$${δ}_{A}^{*} = arg {max}_{{δ}_{A}} {EU}_{{δ}_{A}} ,$$

where δ_{A} is a decision rule (i.e., a conditional distribution).

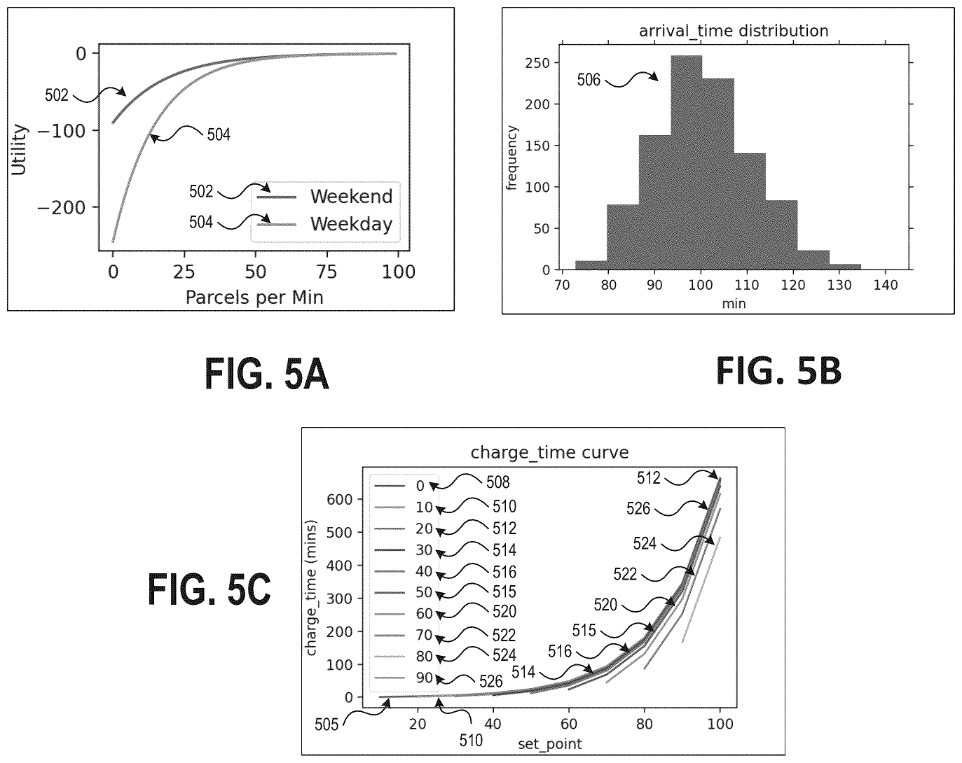

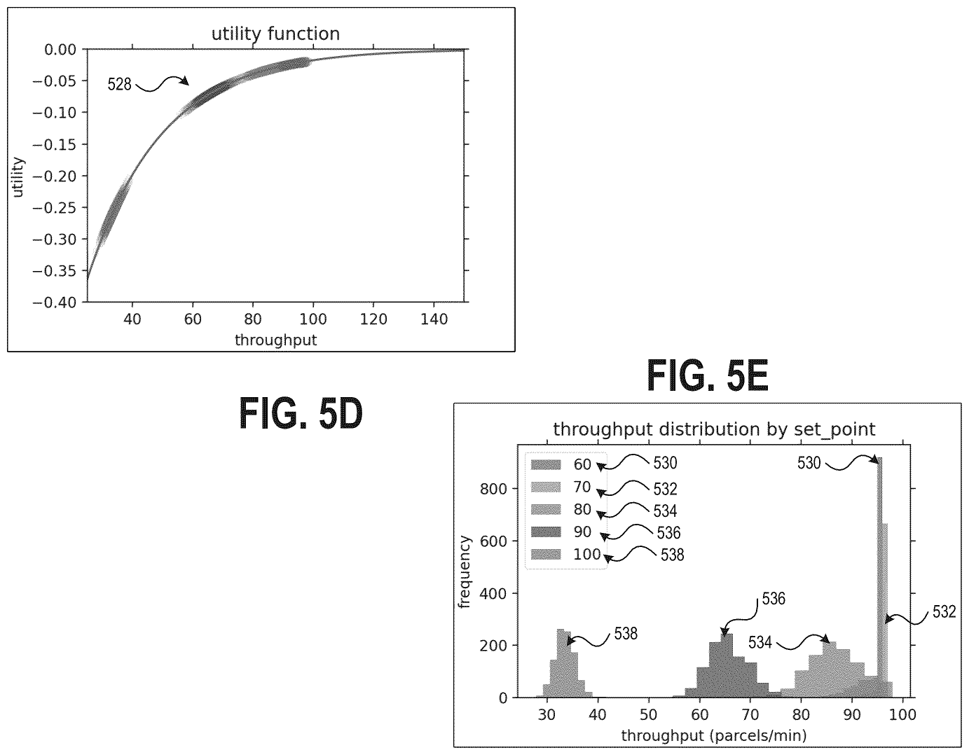

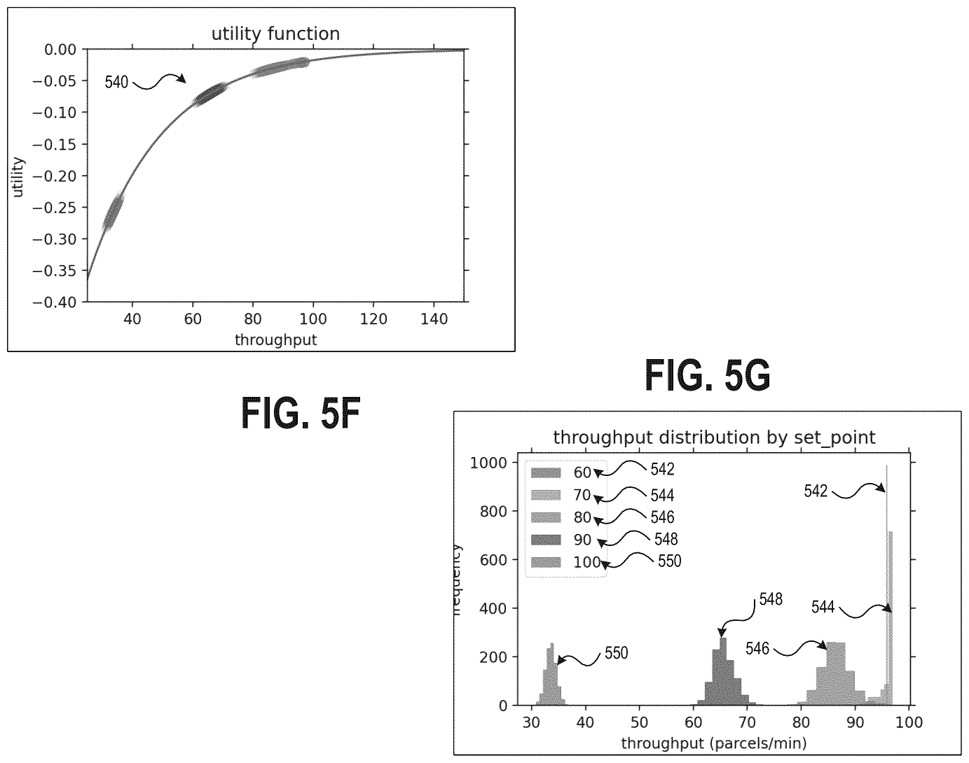

Once the optimization problem is defined, the probabilistic graph model 400″ may be used to solve the optimization problem. As an example, and referring to FIGS. 5A-5C, diagrams illustrating exemplary probability distributions obtained from digital twins generated in accordance with aspects of the present disclosure are shown. In particular, FIG. 5A shows the probability distribution for utility node 470, where plot 502 corresponds to the weekend and plot 504 corresponds to the weekday, and where throughput is represented on the x-axis and utility along the y-axis. In FIG. 5B, the probability distribution for the node 420 representing expected arrival time (in minutes) is shown by histogram 506. In FIG. 5C, the probability distribution for the edge 442 representing the statistical dependency between node 450 and the decision node 440′ is shown and includes plots of charge time curves 508-526. As can be appreciated from FIG. 5C, the statistical dependency between the charge times and the set point (i.e., how long the robot spends charging its battery) configured by the decision node 440′ can be seen by the fact that as the set point (x-axis) decreases, the charge time (y-axis) also decreases, and as the set point increases so too does the charge time.

In FIGS. 5D-5G, probability distributions for throughput and the utility function are shown, where FIG. 5D includes a plot 528 of a probability distribution showing utility as a function of throughput, FIG. 5E shows histograms 530-538 representing probability distributions for throughput across a range of set point values, FIG. 5F includes a plot 540 of a probability distribution showing utility as a function of throughput, FIG. 5G shows histograms 542-550 representing probability distributions for throughput across a range of set point values. It is noted that the probability distributions shown in FIGS. 5D and 5E were generated under the assumption the arrival time (e.g., node 520) was +40 minutes (high variability), while the probability distributions shown in FIGS. 5F and 5G were generated under the assumption arrival time (e.g., node 520) was +20 minutes (low variability). Since the variability of arrival time used in FIGS. 5D and 5E was greater than the variability of the arrival time used for FIGS. 5F and 5G, the probabilistic graph model may consider the optimization of the high variability case (FIGS. 5D and 5E) to include more uncertainty as compared to the low variability case (FIGS. 5F and 5G) which included less uncertainty (e.g., because there was more time in between successive arrival times). The outputs of the probability distributions shown are in Tables 1 and 2 below, which correspond to FIGS. 5D and 5F, respectively, demonstrate that the difference in variability due to the different arrival time parameters impacted the optimal set points. For example, as shown in Table 1, the optimal set point for the high variability case (FIGS. 5D, 5E) was 60% (a more conservative solution) while in the low variability case (FIGS. 5F, 5G) the optimal set point was 70%.

TABLE 1
Expected Utility (EU); High Variability

EU 60: −0.02069131926428976
EU 70: −0.020466693551385823
EU 80: −0.030720889284898047
EU 90: −0.07072122278709567
EU 100: −0.25804187691143965

TABLE 2
EU; Low Variability

EU 60: −0.020889675394317436
EU 70: −0.021609520599207968
EU 80: −0.030856733839585294
EU 90: −0.07022530269832856
EU 100: −0.2589387886581521

It is noted that the exemplary optimization problem described and illustrated with reference to FIGS. 5A-5G has been provided for purposes of illustration, rather than by way of limitation and that digital twins represented using probabilistic graph models generated via extension of knowledge graphs in accordance with the present disclosure may be used to perform other types of optimizations involving different real world counterparts if desired.

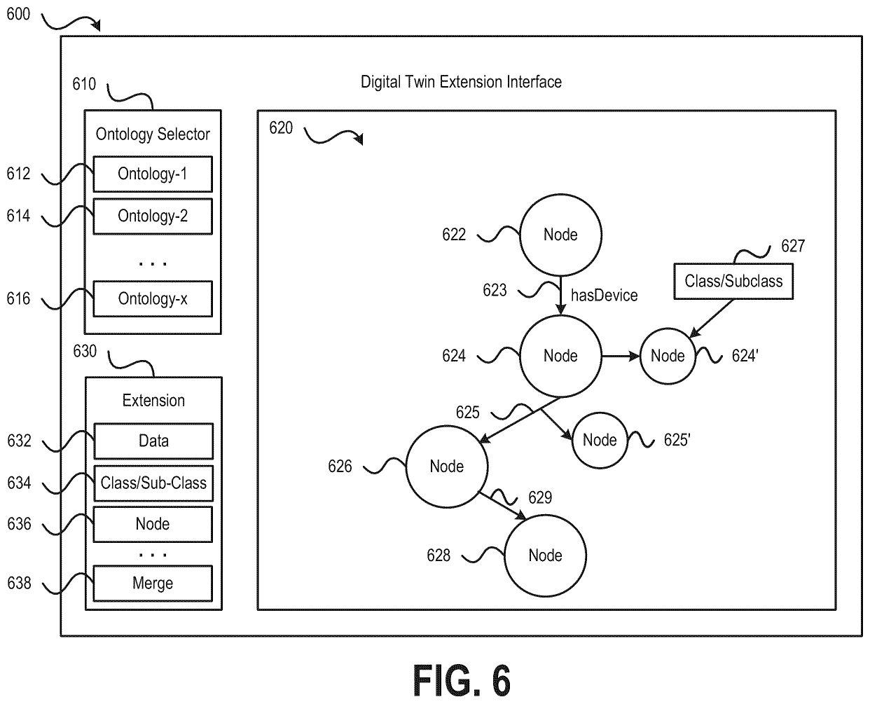

Referring back to FIG. 1, the functionality of the extension engine 124 may be exposed to through one or more GUIs presented to a user. For example and referring to FIG. 6, a block diagram illustrating an exemplary user interface providing functionality for extending knowledge graphs in accordance with aspects of the present disclosure is shown as a GUI 600. As shown in FIG. 6, the GUI 600 includes an ontology selection area 610 including interactive elements 612, 614, 616 for selecting one or more ontologies for use in creating a digital twin in accordance with the concepts described above with reference to FIGS. 1-5G. Upon selection of an ontology (e.g., via activating one of the interactive elements 612, 614, 616), a viewing area 620 of the GUI 620 may be populated with a visual representation of the ontology selected from the ontology selection area 610. In the non-limiting example shown in FIG. 6, the ontology is shown as including a plurality of nodes 622, 624, 626, where nodes 622, 624 are connected via an edge 623 and nodes 624, 626 are connected via edge 625. In an aspect, the representation of the selected ontology may be generated as a knowledge graph by the knowledge engine 122 of FIG. 1, as described above.

Once displayed in the viewing area 620, the user may utilize other interactive elements and controls provided by the GUI 600 to extend the knowledge graph and thereby expand the capabilities of the digital twin being designed. For example, the user may a set of extension tools 630 to extend the digital twin. In the example of FIG. 6, the extension tools 630 are shown as including data extension tools 632, class/sub-class extension tools 634, node extension tools 636, and merging extension tools 638, each of which are described in more detail below.

The data extension tools 632 may provide a set of tools that enable the user to incorporate data into the digital twin, such as time series data or other types of data. To illustrate, using the data extension tools the user may incorporate data nodes into the knowledge graph, such as data nodes 624′, 625′. As described above, the ability to add data nodes may enable collections of data points (e.g., metrics, events, etc.) to be incorporated into the knowledge graph, thereby extending the types of information, analysis, and understanding that may be obtained from the digital twin. In an aspect, the data nodes may be associated with a class or subclass, shown in FIG. 6 as class/subclass 627, which may be beneficial for incorporating certain types of data (e.g., time series data). It is noted that while class/subclass 627 is shown in FIG. 6, the knowledge graph (or probabilistic model derived from the knowledge graph) may not actually include a node or information regarding the specific class, which may be instead imposed as a constraint on the data nodes. It is noted that incorporation of data nodes may be performed with respect to data associated with nodes, as in data node 624′, as well as edges, as in data node 625′. The ability to incorporate data corresponding to both nodes and edges is beneficial as some nodes may be independent of other nodes with respect to statistical dependencies (e.g., as in the age node of FIGS. 2C and 2D), and edges may be used to extract certain types of information from the digital twin based on the statistical dependencies between nodes, as described above with respect to querying of digital twins generated in accordance with the present disclosure.

The class/subclass extension tools 634 may enable a user to define new classes and subclasses, which may enable further customization of the digital twin. For example, the data extension tools 632 may enable a user to add data associated with certain types of class/subclasses, but where a need to incorporate data for which no existing class/subclass is appropriate, the user may utilize the class/subclass extension tools 634 to create new classes accommodate new forms or types of data. Additionally, the ability to define new subclasses may enable new types of data to be added to the knowledge graph while leveraging existing classes and subclasses (e.g., because subclasses derive all features and functionality of their respective base classes).

The node extension tools 636 may enable the user to define new nodes within the digital twin or convert existing nodes to different node types. For example, the user may utilize the node extension tools 636 to add a utility node 628, convert an existing node to a decision node and/or a target node, or other types of node modifications. In an aspect, any node representing an optimizable parameter (e.g., battery charge level/time, duty cycle, etc.) may be configured as a decision node and associated with utility and target nodes using the node extension tools 636.

An additional extension tool is the merge extension tool 638, which may enable the user to merge two or more ontologies selected from the ontology selection area 610. For example, the ontology corresponding to interactive element 612 may be selected and merged with the ontology corresponding to interactive element 614 to create a digital twin of digital twins. The ability to merge digital twins may enable rapid development of complex digital twins that may be used to model real world counterparts in a robust manner. To illustrate, the exemplary digital twins shown in FIGS. 2B-2D and 4A-4C relate to robots, but those robots may be part of an assembly line that includes many robots and the assembly line may be part of manufacturing facility having other subgroups (e.g., shipping/receiving department, a warehouse department, a picking/packing department, a supply chain management system, and so on). Using the merge feature ontologies corresponding to each of these different subgroups can be merged to form a digital twin representing the entire manufacturing facility. Furthermore, the merge extension tools 638 may enable such a digital twin to be merged with other digital twins, such as a digital twin of a logistics provider that moves products between the manufacturing facility and one or more retail outlets, as well as digital twins representing the processes, personnel, equipment and other features related to the retail outlet(s). Thus, the merge extension tools 638 may enable digital twins in accordance with the present disclosure to be generated in a system-of-systems-type manner such that a digital twin of an entire ecosystem can be represented as a digital twin. Moreover, the above-described functionality with respect to the improved querying of information from digital twins may be readily applied to such system-of-system-type digital twins, allowing insights to be obtained from not only a single aspect of the ecosystem, but across all parts of a real world ecosystem. Such capabilities may enable a deeper understanding of interactions between different ecosystem components and even optimization of entire ecosystems. Such capabilities are not feasible using existing digital twin platforms and tools, which are typically designed for specific systems and do not provide extension capabilities, thereby preventing use of one digital twin platform or tool for different use cases and systems.

As can be appreciated from the foregoing, the various functionalities provided by the system 100 enable digital twins to be created in an ontology-driven manner and extended in various ways to increase the knowledge of a real world counterpart (or counterparts) that may be derived or extracted from the digital twin. For example, the system 100 enables a user to create digital twins based on one or more selected ontologies and then configure extensions of the digital twin(s) that provide new forms of knowledge acquisition (e.g., querying, etc.) using digital twins. Moreover, the probabilistic reasoning under uncertainty extension provided by the present disclosure enable various forms of optimization problems to be evaluated using digital twins, which is a capability that was not readily available from existing digital twin platforms and tools. Furthermore, the ability to create digital twins of entire ecosystems (e.g., system-of-systems-based digital twins) enables new forms of learning and understanding how different features or systems within an ecosystem interact and impact each other, thereby providing new ways in which to study ecosystems and their various subsystems or components. Another advantage provided by the system 100 and the various features described above is the ability to dynamically change digital twins. For example, if a process, workflow, or other aspect of a real world counterpart changes, such changes may be updated in an existing digital twin generated in accordance with the present disclosure through modification of the ontology and/or extensions applied to the digital twin, rather than completely redesigning the digital twin, as may be required with existing digital twin platforms or tools.

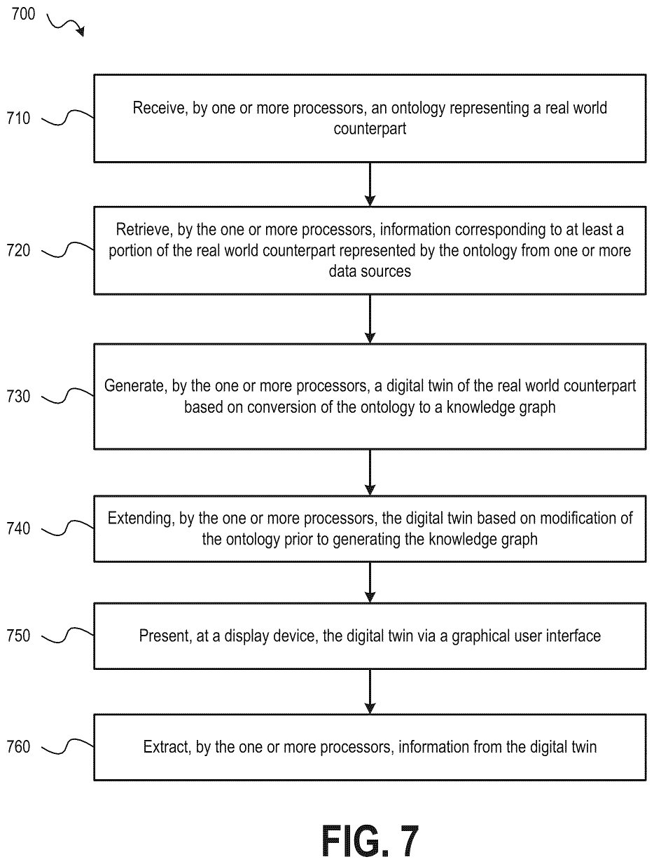

It is noted that the system 100 (e.g., the data ingestion engine 120, the knowledge engine 122, and the extension engine 124 of the computing device 110 of FIG. 1) may leverage various technologies to support the functionality described above with reference to FIGS. 1-6 and below with reference to FIG. 7. For example, the computing device 110 may utilize application programming interfaces (APIs) to obtain information utilized to generate digital twins (e.g., ontologies, data from the one or more data sources 150 of FIG. 1, etc.) and to provide information derived from digital twins to users. Furthermore, while the functionality described herein has been primarily with reference to generating digital twins using the computing device 110 or a cloud-based implementation of the computing device 110 (e.g., the cloud-based system 142 of FIG. 1), it is to be appreciated that the functionality for generating digital twins may also be provided local to a user device (e.g., the user device 130 of FIG. 1). In such an implementation the user device may execute an application for generating digital twins in accordance with aspects of the present disclosure, and the application may be stored as instructions (e.g., the instructions 136) in a memory (e.g., the memory 134) of the user device.

It should also be understood that the present disclosure provides a generalized platform that includes a suite of tools that facilitate rapid creation of digital twins for specific use cases and that may be readily reused or modified for additional use cases, thereby providing more flexibility for modelling real-world counterparts using digital twins and decoupling the digital twin platform and tools from the use cases to which the platform and tools could be applied (e.g., unlike traditional digital twin platforms and tools, the disclosed systems and techniques for producing digital twins are not restricted to particular real-world counterparts, use cases, or analysis). The functionality of the system 100 also provides the advantage of generating digital twins that utilize a single data representation (e.g., data and artificial intelligence (AI)) in which the data model (e.g., the knowledge graph) and the statistical (AI/ML) model of the data (e.g., the probabilistic graph model) are tightly coupled. As such, there is no need to move the data out of the platform to run analytics. Also, since the analytics model is tightly integrated with the data, the data may be expressed both deterministically and probabilistically, which speeds up computation while also reducing the computational resources required to run the analytics.

Referring to FIG. 7, a flow diagram of an exemplary method for generating digital twins having extended capabilities according to one or more aspects of the present disclosure is shown as a method 700. In some implementations, the operations of the method 700 may be stored as instructions that, when executed by one or more processors (e.g., the one or more processors of a computing device or a server), cause the one or more processors to perform the operations of the method 700. In some implementations, the method 700 may be performed by a computing device, such as the computing device 110 or 130 of FIG. 1 (e.g., a computing device configured for generating digital twins), a cloud-based system (e.g., cloud-based system 142 of FIG. 1), or a combination thereof.

At step 710, the method 700 includes receiving, by one or more processors, an ontology representing a real world counterpart. As explained above, the real world counterpart may be a machine (e.g., a robot, a vehicle, a watercraft, an aircraft, and the like), a workflow, a process, an entity or enterprise (e.g., a factory, a warehouse, a logistics company, an agriculture company, a mine, a refinery, an oil and gas production or refinery facility, a business, a software application, a network, Internet of Things (IoT), a communication system, and the like), or a combination thereof. In some aspects, multiple ontologies may be received, each corresponding to a different real world counterpart, thereby enabling complex digital twins to be created that involve ecosystems in which multiple real world counterparts that interact with each other.

At step 720, the method 700 includes retrieving, by the one or more processors, information corresponding to at least a portion of the real world counterpart represented by the ontology from one or more data sources. As described the information corresponding to at least the portion of the real world counterpart may include observations, such as metrics and events, and the one or more data sources may include the data sources 150 of FIG. 1, which include sensors, devices, and/or systems that capture information about the real world counterpart(s). In an aspect, step 720 may be performed periodically, such as to retrieve updated information pertaining to the real world counterpart from the one or more data sources.

At step 730, the method 700 includes generating, by the one or more processors, a digital twin of the real world counterpart based on conversion of the ontology to a knowledge graph. As described above, a knowledge engine (e.g., the knowledge engine 122 of FIG. 1) may be used to generate the knowledge graph based on information extracted from or included in the ontology. Initially, the knowledge graph generated based on the ontology may enable extract of simple logical inferences to be drawn regarding the real world counterpart based on semantic relationships represented by nodes and edges of the knowledge graph. However, additionally types of information may be obtained from digital twins generated in accordance with the present disclosure via extension of the knowledge graph using the concepts disclosed herein and the method 700.

At step 740, the method 700 includes extending, by the one or more processors, the digital twin based on modification of the ontology prior to generating the knowledge graph. In an aspect, extending the digital twin may include embedding collections of data in the digital twin. As described above, the collections of data derived from the retrieved information corresponding to at least the portion of the real world counterpart may include observations, such as events and metrics, and the collections of data may be embedded in the digital twin as data nodes associated with an edge of the knowledge graph or a node of the knowledge graph. In an aspect, one or more classes or subclasses may be selected or defined to control a configuration of the data nodes in which the information is embedded, as described above with reference to FIG. 1 and FIGS. 3A, 3B. In an additional or alternative aspect, extending the digital twin may include modifying a configuration one or more nodes of the knowledge graph, edges of the knowledge graph, or both. For example, as described above, nodes of the knowledge may be converted to different node types (e.g., decision nodes, target nodes, etc.) and edges converted to different edge types (e.g., information edges rather than merely representing semantic relationships) to enable use of the digital twin to perform optimization-type analysis. Additionally, the extension of the digital twin may include introducing at least one additional node to the digital twin, such as a utility node. It is noted that where additional nodes are added to the digital twin, one or more additional edges may also be defined to connect the additional node(s) to other nodes of the knowledge graph-based digital twin.

In an aspect, the extension of the digital twin may be performed using a GUI, such as the GUI 600 of FIG. 6, that provides a set of interactive elements for extending digital twins in accordance with the present disclosure. For example, the ontology or a base knowledge graph generated from the ontology may be displayed in a display area (e.g., the display area 620 of FIG. 6) and a set of extension tools (e.g., the extension tools 630 of FIG. 6) provided via the GUI may be used to extend the digital twin. In addition to the extensions described above, the method 700 may also enable the user to extend a digital twin through creation of classes and/or subclasses that may be used to control the structure of the data nodes used to embed information into the data nodes, as described above with reference to FIGS. 3A and 3B. For example, the data nodes may include event data nodes and metric data nodes. The event data nodes may include information associated with detection (e.g., by the one or more data sources 150) of one or more events. The metric data nodes may include information associated with one or more metrics. In an aspect, the event data nodes and metric data nodes may include collections of observations (e.g., collections of events or collections of metrics), where the collections include a set of metrics of events associated with each other via a collection criterion. For example, as explained above, collections of events or metrics may be organized based on time (e.g., events or metrics observed during a period of time may be grouped), based on device (e.g., each data node stored events or metrics observed by specific devices), or another criterion configured by a user. Incorporating observations into the digital twin using collections may reduce the impact of incorporating data into the digital twin (e.g., by grouping instances of observations in a single data node or observations of a single type (e.g., events or metrics) in a single data node).

At step 750, the method 700 includes presenting, at a display device, the digital twin via the GUI and at step 760, the method 700 includes extracting information from the digital twin via inputs provided to the graphical user interface. For example, the GUI may include interactive elements and a display area the digital twin may be presented, at step 750, in the display area (e.g., the display area 620 of FIG. 6). The interactive elements of the GUI, which include the ontology selection are 610 and the extension tools 630 of FIG. 6, may also include query building tools for generating one or more queries for extracting information from the digital twin. A user may utilize the query building tools to construct queries and then execute them against the digital twin to extract various types of information enabled by the extensions of the digital twin applied at step 740. For example, as described above the extension of the digital twin may enable the base knowledge graph to be transformed to a probabilistic graph model that enables probability-type information and optimization under uncertainty information to be extracted from the digital twin.

It is noted that while the method 700 of FIG. 7 has been described above with respect to generating a digital twin of a single real world counterpart, it should be understood that the method 700 may be readily utilized to generate one or more additional digital twins, each corresponding to a different real world counterpart. Furthermore, the method 700 may be utilized to generate a digital twin-of-digital twins by merging multiple digital twins (e.g., using merging extension tools provided by the interactive elements of the GUI to generate a digital twin based on multiple ontologies). While individual digital twins generated using the method 700 may enable new insights into the real world counterpart not available from existing digital twin platforms and tools, digital twins generated based on multiple ontologies (i.e., digital twins-of-digital twins or digital twins generated in a system-of-systems manner) may enable even more insights and information to be extracted from the real world counterparts represented in the digital twin, such as insights into an ecosystem(s), as well as interactions between different real world counterparts represented within the ecosystem(s).

As shown above, the method 700 provides a use-case agnostic platform supporting generation and extension of digital twins in an ontology-driven manner, thereby enabling the method 700 to be applied to any real world counterparts, as well as entire ecosystems. By exploiting knowledge graphs having integrated domain data, the method 700 enables generation of digital twins supporting probabilistic analysis and the ability to design queries to extract meaningful insights and understanding from the digital twin. Additionally, the probabilistic capabilities provided by digital twins generated using the method 700 enable analysis of the real world counterparts using conditional probability queries with uncertainty quantification and automated “optimal” decision making, providing new applications for digital twins and their use in understanding the real world counterparts. Furthermore, due to the tight coupling of the data embedded within the digital twin, analytics may be obtained from the digital twin itself, rather than requiring the data to be moved to another platform, as is required for some digital twins platforms and tools.

It is noted that other types of devices and functionality may be provided according to aspects of the present disclosure and discussion of specific devices and functionality herein have been provided for purposes of illustration, rather than by way of limitation. It is noted that the operations of the method 700 of FIG. 7 may be performed in any order. It is also noted that the method 700 of FIG. 7 may also include other functionality or operations consistent with the description of the operations of the system 100 of FIG. 1 and the examples shown and described with reference to FIGS. 2A-6. For example, once the final probabilistic graph model is obtained, a query may be defined and ran against the final probabilistic graph model. The query may return a probability distribution derived from the probability distributions of the final probabilistic graph model. Additionally, the method 700 may be used to perform automated “optimal” decision making under uncertainty, as described above with reference to FIGS. 4A-5G. In an aspect, “optimal” decision making under uncertainty in accordance with the present disclosure may only need the user to input a target for the optimization and a set point (or decision node) while the utility node may be established automatically. Furthermore, the user may be enabled to configure constraints for the automated “optimal” decision making under uncertainty process and selectively implement, modify, or ignore a recommendation resulting from the optimization analysis (e.g., the digital twin may output a recommendation based on an optimal decision making under uncertainty problem and the user may follow the recommendation exactly, ignore the recommendation entirely, or partially follow the recommendation (e.g., if the recommendation is to charge a battery to 70% the user may choose to set the charging target to a value greater than or less than 70%)).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A system for generating digital twins, the system comprising:
a memory;
one or more processors communicatively coupled to the memory;
a data ingestion engine executable by the one or more processors and adapted to:
receive an ontology representing a real world counterpart;
retrieve information corresponding to at least a portion of the real world counterpart represented by the ontology from one or more data sources;
a knowledge engine executable by the one or more processors and adapted to generate a digital twin of the real world counterpart based on the instantiation of the ontology as a knowledge graph;
an extension engine executable by the one or more processors and adapted to extend the digital twin, wherein extending the digital twin comprises at least one of:
embedding collections of data in the digital twin, the collections of data derived from the retrieved information corresponding to at least the portion of the real world counterpart, wherein the collections of data are embedded in the digital twin as embedded data nodes associated with an edge of the knowledge graph or a node of the knowledge graph;
modifying a configuration node of the knowledge graph, edges of the knowledge graph, or both; and
introducing at least one additional node to the digital twin; and
a graphical user interface comprising interactive elements and a display area, wherein the interactive elements are configured to produce the digital twin via interaction with the data ingestion engine, the knowledge engine, and the extension engine, the interactive elements further configured to generate queries for extracting information from the digital twin, and wherein the display area is configured to present a graphical representation of the digital twin.

2. The system of claim 1, wherein the embedded data nodes comprise event data nodes and metric data nodes, the event data nodes configured to store, within the digital twin, information associated with one or more events and the metric data nodes configured to store, within the digital twin, information associated with one or more metrics.

3. The system of claim 2, wherein the interactive elements of the graphical user interface comprise a set of interactive elements for defining the one or more events

4. The system of claim 2, wherein the interactive elements of the graphical user interface comprise a set of interactive elements for defining the metrics.

5. The system of claim 2, wherein the interactive elements of the graphical user interface comprise one or more interactive elements for defining a frequency for generating the event data nodes and the metric data nodes, and wherein the frequency for generating the event data nodes and the metric data nodes is based on a device observing the one or more events or the one or more metrics, based on a period of time, or a combination thereof.

6. The system of claim 1, wherein modifying the configuration of the nodes of the knowledge graph comprises converting a first node of the knowledge graph from a first node type to a second node type, the first node type corresponding to a node type derived from the received ontology and the second node type corresponding to a decision node type or a target node type.

7. The system of claim 1, wherein modifying the configuration of the edges of the knowledge graph comprises converting at least one edge of the knowledge graph from a first edge type to a second edge type, the edge node type corresponding to an edge type identifying a statistical dependency between nodes connected by the at least one edge to an information edge type.

8. The system of claim 1, wherein the extension engine is configured to extend the digital twin via modification of the ontology, and wherein the knowledge engine or the extension engine are configured to transform the knowledge graph to a probabilistic graph model for extracting probability distribution-based data from the digital twin.

9. The system of claim 1, wherein the real world counterpart is a machine, a workflow, a process, an entity or enterprise, or a combination thereof.

10. The system of claim 1, wherein the extension engine is configured to extend the digital twin by merging a first digital twin and a second digital twin.

11. A method for generating digital twins, the method comprising:
receiving, by one or more processors, an ontology representing a real world counterpart;
retrieving, by the one or more processors, information corresponding to at least a portion of the real world counterpart represented by the ontology from one or more data sources;
generating, by the one or more processors, a digital twin of the real world counterpart based on instantiation of the ontology as a knowledge graph; and
extending, by the one or more processors, the digital twin based on modification of the ontology prior to generating the knowledge graph, wherein extending the digital twin comprises at least one of:
embedding collections of data in the digital twin, the collections of data derived from the retrieved information corresponding to at least the portion of the real world counterpart, wherein the collections of data are embedded in the digital twin as embedded data nodes associated with an edge of the knowledge graph or a node of the knowledge graph;
modifying a configuration nodes of the knowledge graph, edges of the knowledge graph, or both; and
introducing at least one additional node to the digital twin.

12. The method of claim 11, wherein the embedded data nodes comprise event data nodes and metric data nodes, the event data nodes comprising information associated with detection of one or more events and the metric data nodes comprising information associated with one or more metrics, the method further comprising:
presenting, at a display device, a graphical user interface comprising interactive elements and a display area, wherein the interactive elements comprise:
a first set of interactive elements for defining the one or more events and the one or more metrics; and
a second set of interactive elements for defining a frequency for generating the event data nodes and the metric data nodes, and wherein the frequency for generating the event data nodes and the metric data nodes is based on a device observing the one or more events or the one or more metrics, based on a period of time, or a combination thereof.

13. The method of claim 11, wherein modifying the configuration of the nodes of the knowledge graph comprises converting a first node of the knowledge graph from a first node type to a second node type, the first node type corresponding to a node type derived from the received ontology and the second node type corresponding to a decision node type or a target node type.

14. The method of claim 11, wherein modifying the configuration of the edges of the knowledge graph comprises converting at least one edge of the knowledge graph from a first edge type to a second edge type, the edge node type corresponding to an edge type identifying a statistical dependency between nodes connected by the at least one edge to an information edge type.

15. The method of claim 11, further comprising transforming the knowledge graph to a probabilistic graph model for extracting probability distribution-based data inferences from the digital twin.

16. The method of claim 11, wherein the real world counterpart is a machine, a workflow, a process, an entity or enterprise, or a combination thereof.

17. The method of claim 11, further comprising:
generating one or more additional digital twins; and
generating a digital twin-of-digital twins by merging the digital twin and the one or more additional digital twins.

18. A non-transitory computer-readable storage medium storing instructions that, when executed by one or more processors, cause the one or more processors to perform operations for generating digital twins, the method comprising:
receiving an ontology representing a real world counterpart;
retrieving information corresponding to at least a portion of the real world counterpart represented by the ontology from one or more data sources;
generating a digital twin of the real world counterpart based on instantiation of the ontology as a knowledge graph; and
extending the digital twin based on modification of the ontology prior to generating the knowledge graph, wherein extending the digital twin comprises at least one of:
embedding collections of data in the digital twin, the collections of data derived from the retrieved information corresponding to at least the portion of the real world counterpart, wherein the collections of data are embedded in the digital twin as embedded data nodes associated with an edge of the knowledge graph or a node of the knowledge graph;
modifying a configuration nodes of the knowledge graph, edges of the knowledge graph, or both; and
introducing at least one additional node to the digital twin.

19. The non-transitory computer-readable storage medium of claim 18, wherein the real world counterpart is a machine, a workflow, a process, an entity or enterprise, or a combination thereof.

20. The non-transitory computer-readable storage medium of claim 18, the operations further comprising:
generating one or more additional digital twins; and
generating a digital twin-of-digital twins by merging the digital twin and the one or more additional digital twins.
